(19) United States
(12) Patent Application Publication
(10) Pub. No.: US 2012/0133750 A1
(43) Pub. Date: May 31, 2012

(54) IMAGING SENSOR WITH DATA SPLITTING

(75) Inventors: Joshua D. Talbert, Cottonwood Heights, UT (US); Jeremiah D. Henley, Cottonwood Heights, UT (US); Donald M. Wichern, South Ogden, UT (US)

(73) Assignee: OLIVE MEDICAL CORPORATION, Sandy, UT (US)

(21) Appl. No.: 13/115,938

(22) Filed: May 25, 2011

Related U.S. Application Data
(60) Provisional application No. 61/348,196, filed on May 25, 2010.

(51) Int. Cl. H04N 5/08; H04N 7/18

(52) U.S. Cl. 348/65; 348/525; 348/E05.017; 348/E07.085

(57) ABSTRACT

A system, apparatus and methods for providing a single use imaging device utilizing split data streams to maximize the data transfer rate between components for use in sterile environments is disclosed and described. A single use high definition camera used for general purpose surgical procedures including, but not limited to: arthroscopic, laparoscopic, gynecologic, and urologic procedures, may comprise an imaging device that is a sterile and designed to ensure single use. The imaging device may have one or more imaging sensors, either CCD or CMOS, encased in a housing. The imaging device may further components for splitting the transmitted data.

### CROSS-REFERENCE TO RELATED APPLICATIONS

This application claims the benefit of U.S. Provisional Application No. 61/348,196, filed on May 25, 2010, which is hereby incorporated by reference herein in its entirety, including but not limited to those portions that specifically appear hereinafter, the incorporation by reference being made with the following exception: In the event that any portion of the above-referenced provisional application is inconsistent with this application, this application supercedes said above-referenced provisional application.

### STATEMENT REGARDING FEDERALLY SPONSORED RESEARCH OR DEVELOPMENT

Not Applicable.

### BACKGROUND

The disclosure relates generally to imaging devices used during surgical procedures to visualize a surgical area, and more particularly, but not necessarily entirely, to an imaging device and a data distribution and transmission system, apparatus and method.

Endoscopic surgery is experiencing rapid growth in the medical field. Endoscopy is a minimally invasive surgical procedure that is used to analyze the interior of a body cavity or interior surfaces of an organ by inserting a tubular member into the body cavity through a minor or minimal incision. A conventional endoscope is generally an instrument with a light source and an image sensor or device for visualizing the interior a body cavity. A wide range of applications have been developed for the general field of endoscopes including, but not necessarily limited to: arthroscope, angioscope, bronchoscope, choledochoscope, colonoscope, cytoscope, duodenoscope, enteroscope, esophagogastro-duodenoscope (gastroscope), laparoscope, laryngoscope, nasopharyngo-neproscope, sigmoidoscope, thoracoscope, and utererscope (hereinafter referred to generally as “endoscope”). The advantages of endoscopy include smaller surgical incisions and less soft tissue damage. As a result, there is significantly less discomfort and pain for the patient as well as a decrease in recovery time.

The advantages of minimally invasive surgery performed with the help of an endoscope are well known and understood in the medical field. As a result, there have been a growing number of devices for use with endoscopes for delivering, for example, diagnostic, monitoring, treatment, operating instruments, tools, and accessories (collectively, “tools”) into the observation field and working space of the physician's endoscope.

As part of forming an image of the surgical site, the endoscope includes a light source and an image sensor. Endoscopes may also incorporate more than one tubular member for observation or operation within the body, such as a working channel for passing diagnostic, monitoring, treatment, or surgical tools through the endoscope. Endoscopes include glass lenses and an adjustable ocular or eye piece, a lateral connection for a light conductor, an adaptor that allows focusing, and a camera head. This configuration is also called a video endoscope.

Additionally, imaging devices are subject to governmental regulations, for example the FDA in the United States, to protect patients and surgeons from potential burns and electric shock that may result in injury. These devices may be made in accordance and consistent with, inter alia, International Electrotechnical Commission (“IEC”) standard 60601-1.

It is axiomatic that strict sterilization of the operating room and surgical equipment is required during any surgery. The strict hygiene and sterilization conditions required in a “surgical theater,” i.e., operating or treatment room, necessitate the highest possible sterility of all medical devices and equipment. Part of that sterilization process is the need to sterilize anything that comes in contact with the patient or penetrates the sterile field, including the endoscope and its attachments and components. It will be appreciated that the sterile field may be considered a specified area, such as within a tray or on a sterile towel, that is considered free of microorganisms; or the sterile field may be considered an area immediately around a patient that has been prepared for a surgical procedure. The sterile field may include the scrubbed team members, who are properly attired, and all furniture and fixtures in the area.

In recent years there has been a trend of providing a single use endoscope and components as a packaged, sterilized product, similar to a package containing a surgical implant, such as a knee or hip implant. In terms of endoscopy, instead of using endoscopes that have been reconditioned for each new surgery through traditional sterilization procedures, it means using a single use endoscope and components that are delivered to the hospital in a sterilized package. Due to this trend, it has become increasingly difficult to ensure that each endoscope and its components are properly cared for, used and sterilized for single use and not simply re-sterilized using traditional sterilization procedures.

Traditional drawbacks or problems of video endoscopes include a lack of image quality, the need for sterilization and high manufacturing cost as well as high processing cost. To address these and potentially other problems, the disclosure utilizes unique imaging devices or sensors in addition to a unique method, system and process for providing and reclaiming single use imaging devices. Part of this method and process includes minimizing the costs associated with the imaging device and other associated equipment to be used as a single use device. The disclosure may use a data distribution and transmission system, apparatus and method to reduce the costs associated with the imaging device and other equipment.

The features and advantages of the disclosure will be set forth in the description that follows, and in part will be apparent from the description, or may be learned by the practice of the disclosure without undue experimentation. The features and advantages of the disclosure may be realized and obtained by means of the instruments and combinations particularly pointed out herein.

### SUMMARY OF THE DISCLOSURE

An embodiment may comprise a single use camera used for general purpose surgical procedures including, but not limited to: arthroscopic, laparoscopic, gynecologic, and urologic. An embodiment may comprise an imaging device that is a sterile and designed to ensure single use. An embodiment may be an imaging device that comprises a single imaging sensor, either CCD (charge coupled device) or CMOS (complementary metal oxide semiconductor), encased in a molded plastic housing. The imaging device may further comprise the means to be attached to an optical coupling device, using C-Mount and CS-Mount threads or another proprietary or unique connection method. It is within the disclosure to include integrated optical systems, such that no specific coupling means is required. The imaging device may further comprise a cable or wireless method to transmit data to and from a camera control unit. An embodiment may further comprise a thermal energy dissipation means such as a heat sink or cooling mechanism.

An embodiment may comprise a thermal pad that may be substantially rigid or may be deformable. An embodiment may comprise a thermal pad that may be configured to cover substantially all of the surface contact area between the heat sink and any heat generating circuitry. An embodiment may comprise a thermal pad that may be configured to cover a portion of the surface contact area between the heat sink and any heat generating circuitry. An embodiment may comprise a thermal pad that may be configured to cover a plurality of surface contact areas. An embodiment may comprise a thermal pad that may comprise a plurality of thermal pads working on a single surface contact area. An embodiment may comprise a plurality of thermal pads working on a plurality of surface contact areas. An embodiment may comprise a thermal pad having areas of varying thickness configured to accommodate the structure and geometry of surrounding components. An embodiment may comprise a thermal pad comprising a plurality of materials. An embodiment may comprise a thermal pad comprising fold lines.

In an embodiment, information will be recorded in the memory of the imaging device each time it is used in a procedure or quality control (QC) checked at the manufacturer. This information may be used to evaluate usage time, expiration date, etc. An embodiment may comprise features to ensure that the imaging device is only used once and that the imaging device is safe for use.

In an embodiment, the imaging device may be fully covered in plastic having a sensor heat sink to ensure the camera head meets cardiac floating (CF) and body floating (BF) IEC and ISO standards. An embodiment may comprise an imaging device that may be stamped with the current time when plugged into a console in the field after a quality control check has been performed. This time may be used as a baseline for usage. If the imaging device is powered off for a predetermined period of time, which may be equivalent to a sterilization cycle, then the imaging device will not function. The imaging device may display an onscreen message telling the user that the camera has already been used and will not allow current operation. These features ensure the imaging device will not be used more than one time per sterilization cycle and further ensures that proper sterilization is performed by the manufacturer or other authorized source. This function is to protect the patient and the doctor from an invalid or unsafe use.

In an embodiment an active imaging device may be attached to a control unit. The control unit will check the last sterilization date and ensure that the imaging device is no older than a predetermined safety date. If the imaging device is older than the required date, an onscreen warning will tell the user that the imaging device has expired and is unsafe for use. These features will protect the patient and the doctor from using a non-sterile imaging device.

In an embodiment a security code or some other means of identifying, and validating for use, an imaging device by a control unit maybe provided in order to verify that the imaging device is authorized for use. A validating security code or procedure of validation may be distributed to control units from a central database over the internet, by direct transfer from portable storage device such as USB device containing memory, another computer, or other storage device.

In an embodiment, data splitting may be performed by appropriate components with an imaging device and transmitted over a plurality of differential pairs. After being transmitted the video data may be reconstructed by components within a camera head. Clock synchronization may be performed by delaying a signal by N clock cycles until the video data is aligned.

### BRIEF DESCRIPTION OF THE DRAWINGS

The features and advantages of the disclosure will become apparent from a consideration of the subsequent detailed description presented in connection with the accompanying drawings in which:

FIG. 1 is an illustration of an embodiment of the features of the disclosure and made in accordance with the teachings and principles of the disclosure;

FIG. 2 is an illustration of an embodiment of an imaging system made in accordance with the teachings and principles of the disclosure;

FIG. 3 is an illustration of an imaging system having wireless features made in accordance with the teachings and principles of the disclosure;

FIG. 4 is an illustration of an embodiment of a control unit disconnected from an imaging device, but illustrated as remaining connected to complementary apparatuses, and made in accordance with the teachings and principles of the disclosure;

FIG. 5 is an illustration of an embodiment of a control unit display made in accordance with the teachings and principles of the disclosure;

FIG. 6 is an illustration of an embodiment of a retractable display of a control unit in a retracted or closed position and made in accordance with the teachings and principles of the disclosure;

FIG. 6A is an illustration of an embodiment of a retractable display of a control unit in an open position and made in accordance with the teachings and principles of the disclosure;

FIG. 7 is a cross-sectional view of an embodiment of an imaging device head made in accordance with the teachings and principles of the disclosure;

FIG. 8 is a cross-sectional view of an embodiment of an imaging device head made in accordance with the teachings and principles of the disclosure;

FIG. 9 is a cross-sectional view of an embodiment of an imaging device head made in accordance with the teachings and principles of the disclosure;

FIG. 10 is a cross-sectional view of an embodiment of an imaging device head having a ball joint made in accordance with the teachings and principles of the disclosure;

FIG. 11 is a cross-sectional view of an embodiment of an imaging device head made in accordance with the teachings and principles of the disclosure;

FIG. 12 is a layout view of an embodiment of an imaging system made in accordance with the teachings and principles of the disclosure;

FIG. 13 is a schematic diagram of a memory of an embodiment of an imaging system made in accordance with the teachings and principles of the disclosure;

FIG. 14 illustrates an embodiment of a method in accordance with the teachings and principles of the disclosure;

FIG. 15 illustrates an embodiment of a method in accordance with the teachings and principles of the disclosure;

FIG. 16 illustrates an embodiment of a method in accordance with the teachings and principles of the disclosure;

FIG. 17 illustrates an embodiment of a method of use according to the teachings and principles of the disclosure;

FIG. 18 illustrates an embodiment of a method of reclaiming an imaging device after use according to the teachings and principles of the disclosure;

FIG. 19 illustrates an embodiment of a method of making an imaging device for use in a sterilized environment according to the teachings and principles of the disclosure;

FIG. 20 illustrates an embodiment of a method for updating an imaging device system;

FIG. 21 illustrates an embodiment of a system for providing updates to an imaging system;

FIG. 22 is a cross-sectional view of an embodiment of an imaging device head in accordance with the teachings and principles of the disclosure;

FIG. 23 is a cross-sectional view of an embodiment of an imaging device head made in accordance with the teachings and principles of the disclosure;

FIG. 24 illustrates a schematic of an imaging device consistent with the disclosure;

FIG. 25 illustrates a detailed schematic of an imaging device consistent with the disclosure;

FIG. 26 illustrates a diagram of an embodiment of an imaging system consistent with the disclosure;

FIG. 27 illustrates a schematic of clock cycle manipulation consistent with the disclosure;

FIG. 28 illustrates a schematic of several clock cycles consistent with the disclosure;

FIG. 29 illustrates the use of sync data to control a plurality of components;

FIG. 30 illustrates a transmission component consistent with the disclosure;

FIG. 31 illustrates a transmission component consistent with the disclosure; and

FIG. 32 illustrates a transmission component consistent with the disclosure.

### DETAILED DESCRIPTION

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure claimed.

Before the devices, systems, methods and processes for providing and reclaiming single use imaging devices, and distributing and transmitting image data are disclosed and described, it is to be understood that this disclosure is not limited to the particular embodiments, configurations, or process steps disclosed herein as such embodiments, configurations, or process steps may vary somewhat. It is also to be understood that the terminology employed herein is used for the purpose of describing particular embodiments only and is not intended to be limiting since the scope of the disclosure will be limited only by the appended claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterized by,” and grammatical equivalents thereof are inclusive or open-ended terms that do not exclude additional, unrecited elements or method steps.

As used herein, the phrase “consisting of” and grammatical equivalents thereof exclude any element, step, or ingredient not specified in the claim.

As used herein, the phrase “consisting essentially of” and grammatical equivalents thereof limit the scope of a claim to the specified materials or steps and those that do not materially affect the basic and novel characteristic or characteristics of the claimed disclosure.

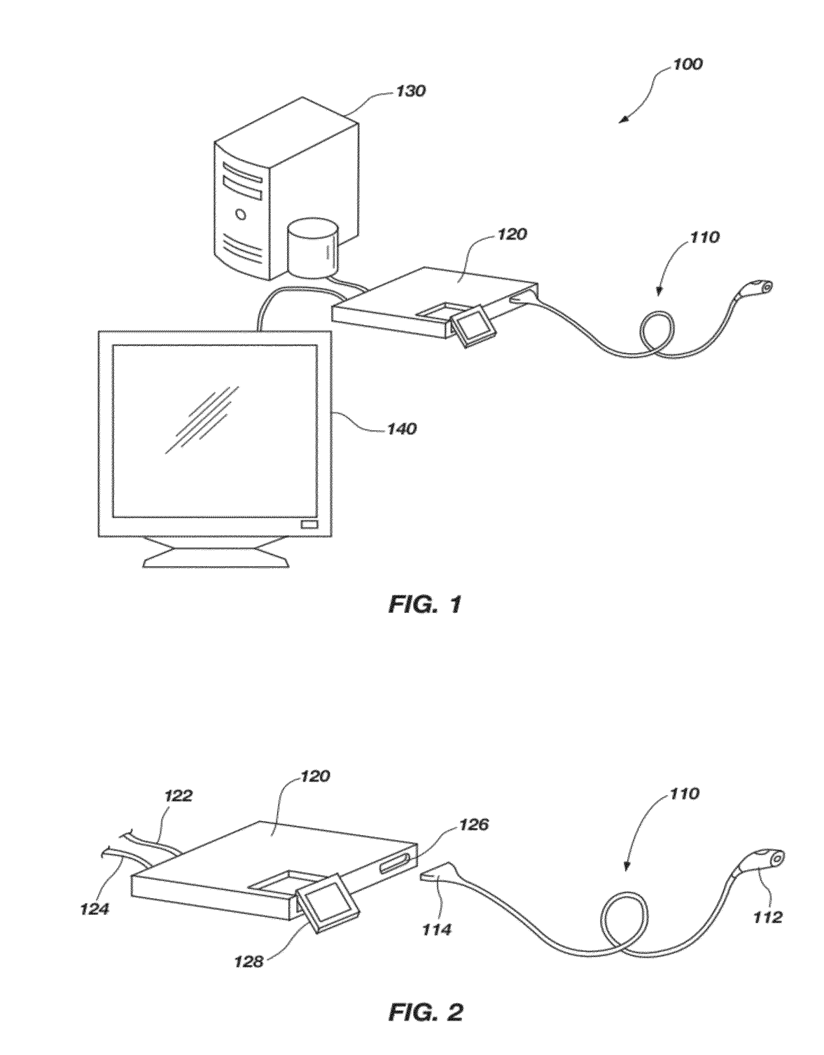

With reference primarily to FIG. 1, an embodiment of the features of the disclosure will be discussed generally. FIG. 1 illustrates a system 100 for providing a digital image using a remote imaging device 110 that may be tethered electronically and physically to a control unit 120. The control unit 120 may be configured to exchange data with imaging device 110 in order to provide single use functionality and safety in a sterile environment, such as an operating room, a doctor's office or dental office. Additionally, the control unit 120 may be electrically connected to a computer 130 or external monitor 140 for increased functionality.

Referring now to FIG. 2 where the imaging system 100 will be discussed in greater detail. As is illustrated in FIG. 2, the imaging device 110 can be connected or disconnected from the control unit 120 by way of an electronic connector 114 on the imaging device 110 that is configured to electronically and physically interact with a corresponding electronic connector 126 on the control unit 120. The ability to disconnect the imaging device 110 from the control unit 120 provides the ability to easily replace a used imaging device 110 for a sterilized, renewed imaging device 110. The imaging device 110 may have a head portion 112 generally positioned remotely from the electronic connector 114, thereby allowing greater mobility of the head portion 112 during use.

Also illustrated in FIG. 2 is an embodiment of the control unit 120 having an electronic connector 126 therein for receiving the corresponding electronic connector 114 of the imaging device 110. The control unit 120 may also have a display 128 for conveying information during a procedure to an operator or user. The display 128 may also comprise interactive functionality allowing an operator to enter commands or change what information is being displayed. Such functionality may be provided by a touch screen system as is commonly known. The control unit may also have video inputs 122 and video outputs 124 for transferring image data to other apparatuses for increased functionality. As illustrated in FIG. 1, common apparatuses may be a computer 130 or an external monitor 140.

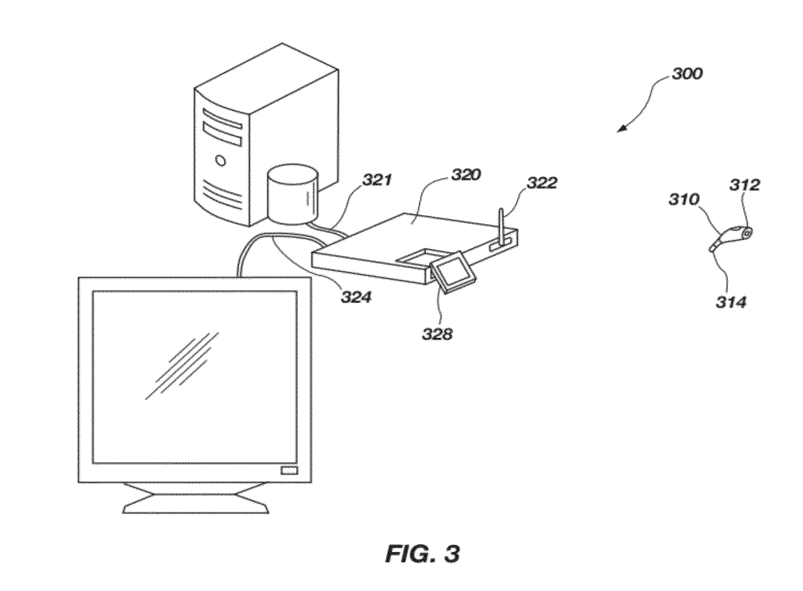

Referring now to FIG. 3 an imaging system 300 will be discussed having wireless capability and features. As is illustrated in FIG. 3, the imaging device 310 may communicate with a control unit 320 by way of wireless transmissions such as Wifi, infrared, bluetooth etc. Other forms of wireless non-tethered connectivity may also be used for providing communication between the imaging device 310 and control unit 320, including but not limited to, radio frequency from any available spectrum, infrared of all configurations, ultrasonic, and optical. The imaging device 310 may comprise a head portion 312 that houses an imaging sensor, memory and associated circuitry, which will be discussed in greater detail below. It will be appreciated that “an image sensor” includes a single image sensor as well as a plurality of image sensors, without departing from the scope of the disclosure. The head portion 312 may further comprise a wireless transceiver 314 for communicating with a corresponding wireless transceiver 322 housed in the control unit 320. The ability to separate the head portion 312 from the control unit 320 via wireless transmissions may provide for the easy replacement of used imaging devices for sterilized and renewed imaging devices. In other words, the wireless communication may be enabled by an electronic communication circuit that is a wireless communication transceiver configured to communicate wirelessly with a corresponding transceiver on said control unit using any of the above noted wireless technologies. The wireless functionality also allows for greater mobility of the head portion 312 during use. It will be appreciated that the wireless features and functionality may be incorporated into any of the embodiments disclosed herein or embodiments that fall within the scope of this disclosure.

Also illustrated in FIG. 3 is an embodiment of the control unit 320 having wireless capabilities and features. A transceiver 322 may be provided in or as part of the control unit 320 for receiving and transmitting wireless data to the imaging device 310. The control unit 320 may also have a display 328 for conveying information during a procedure to an operator or user. The display 328 may also comprise interactive functionality allowing an operator to enter commands or change what information is being displayed. Such functionality may be provided by a touch screen system as is commonly known. The control unit 320 may also have video inputs 321 and video outputs 324 for transferring image data to other apparatuses for increased functionality. As illustrated in FIG. 1 common apparatuses may be a computer 130 or an external monitor 140. It is within the scope of this disclosure to include an imaging system comprising both wired and wireless communication capabilities.

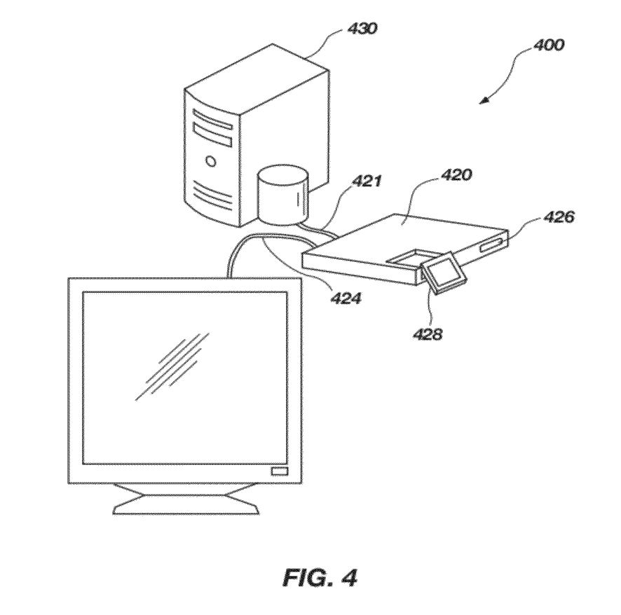

Illustrated in FIG. 4 is an embodiment of the control unit 420 disconnected from an imaging device that is illustrated as being connected to complementary apparatuses. A connector 426 may be provided therein for transferring data to and from an imaging device. The ability to separate the imaging device may provide for the easy replacement of used imaging devices with sterilized and renewed imaging devices. The control unit 420 may also have a display 428 for conveying to an operator information during a procedure. The display 428 may also comprise interactive functionality allowing an operator to enter commands or change what information is being displayed. Such functionality may be provided by a touch screen system as is commonly known. The control unit may also have video inputs 421 and video outputs 424 for transferring image data to other apparatuses for increased functionality. Common apparatuses may be a computer 430 or an external monitor 440 there by increasing the technical functionality of the system 400. A computer 430 may be used for storing the digital output from the imaging system or may be used to enhance and provide further adjustment within the system. An external monitor 440 may be used to show real time digital images to aid an operator in the use of the system, or later review and study the recorded digital imagery.

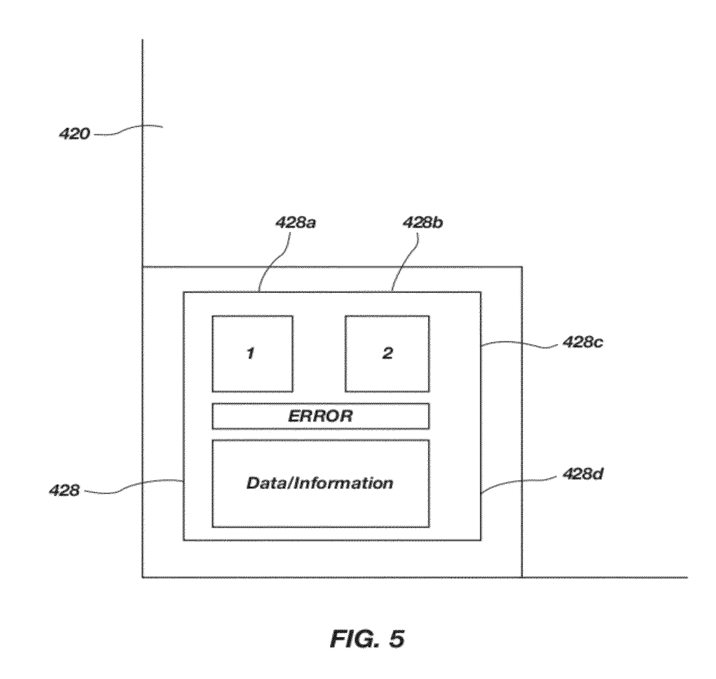

Referring now to FIG. 5 an embodiment of a control unit display 428 that may be part of a control unit 420 will be discussed in greater detail. The display 428 may be a digital display of liquid crystal design (LCD), or the display may be some other technology beside LCD, and may have touch screen functionality and capability for an operator or user to input commands into the system 400. The embodiment discussed herein may have input portions 428a and 428b whereby an operator or user may input commands into the system 400. The embodiment may further comprise a status portion 428c informing a user about the operational status of the components of the system 400. For example, display portion 428c may display an error message related to the condition of an attached imaging device 410 if the imaging device 410 has already been used or has been deemed unfit for a procedure. The display 428 may also have a dedicated message portion 428d providing instructions and further information to an operator or user. The configuration of the display 428 may change during use to accommodate further functionality. A plurality of displays 428 is contemplated by, and falls within the scope of, this disclosure and may be used alternatively or in conjunction with this embodiment. An embodiment may comprise a key pad or a button pad for control purposes within a control unit.

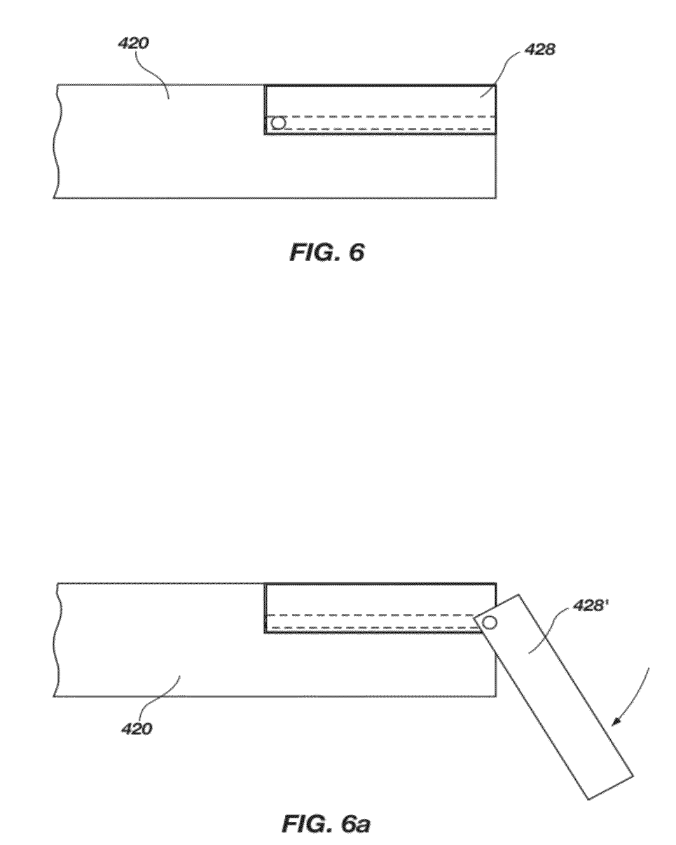

Illustrated in FIGS. 6 and 6A is an embodiment of a retractable display 428 of a control unit 420. The display 428 may have a first or retracted position within the control unit 420 (illustrated best in FIG. 6) that may be used to protect the display 428 when it is not being used. The display 428′ of FIG. 6A illustrates how the display may be deployed into a more user readable position, as it has been extended and rotated outward. As illustrated in FIGS. 6 and 6A, the display may be slid in and out of a passage and rotated about an axis to orient the display 428 in a wide range of positions.

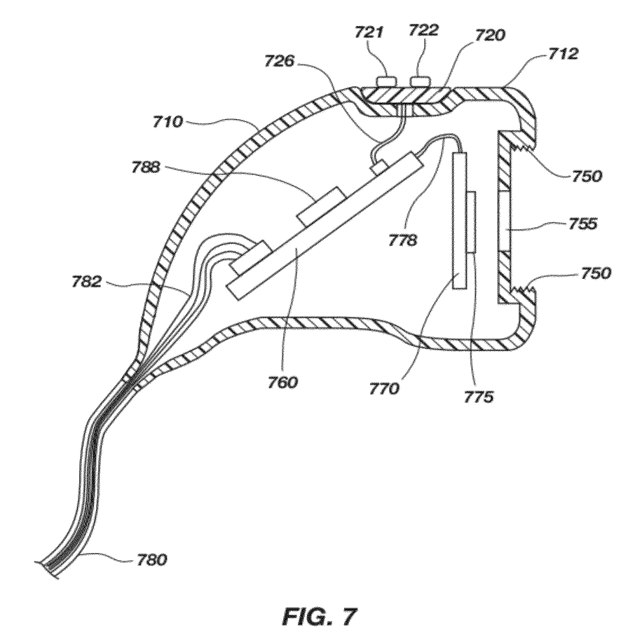

Illustrated in FIG. 7 is a cross-sectional view of an embodiment of an imaging device head 712. The imaging device head 712 may comprise a housing 710 made of a suitably rigid material, such as plastic or metal. The housing 710 may be sealed against fluids and gases so as to protect the internal circuitry and provide a suitable surface for sterilization and renewal. The imaging device head 712 may further comprise a user input panel 720 having buttons 721 and 722 for operation of the imaging device head 712. Additional, buttons may be provided and the functionality of the buttons can be customized for a given procedure or a given operator. The control panel 720 may be internally connected to other circuitry of the imaging device head 712 by an electrical connector 726.

As illustrated further in FIG. 7, imaging device head 712 may comprise an optical mount system 750, such as a C-mount system for receiving threaded accessories, for example one inch threaded accessories. A window 755 may also be incorporated into the embodiment for facilitating the transmission of light from an optical accessory to an image sensor 775. The image sensor 775 may be mounted to a supporting printed circuit board or supportive substrate 770. An electronic connector 778 may be incorporated to electronically connect the image sensor 775 to a main circuit or main printed circuit board 760. A main wiring harness 782 may be incorporated into a wired tether 780 thereby electrically connecting the components of the imaging device head 712 to a control unit.

The imaging device head 712 may further comprise a memory 788 or memory circuit allowing the storage of data within the imaging device head 712. It will be appreciated that memory may be any data storage device that is capable of recording (storing) information (data). Data that may be stored or written into memory 788 may include an identifying serial number that uniquely identifies an imaging device. Other data that may be stored or written into memory 788 may include data such as the amount of the time the imaging device has been used, i.e., the hours of operation, or the amount of time the imaging device has been powered on. Data that may be written into memory 788 may include sterilization data or renewal data, representing the working condition of the imaging device. Data that may be stored or written into memory 788 may include data such as manufacturing date, date of last verification or quality control check, location of manufacture, i.e., may include name, city, state, street address and so forth, last control unit that the imaging device head was attached to, imaging device head diagnostic information, specific procedural settings for the imaging device head, or preferred settings for an operator or user, such as a surgeon. Data representing the above characteristics, or other indicia, of the imaging device may be recorded into memory within the imaging device.

The memory 788 may be encryption protected so as to avoid tampering or unintended use and foreseeable misuse. It should be noted that a memory 788 may be placed anywhere in the imaging device and not just the imaging device head without departing from the scope of the disclosure. The memory 788 may comprise a permanent or semi-permanent portion allowing varying degrees of data durability.

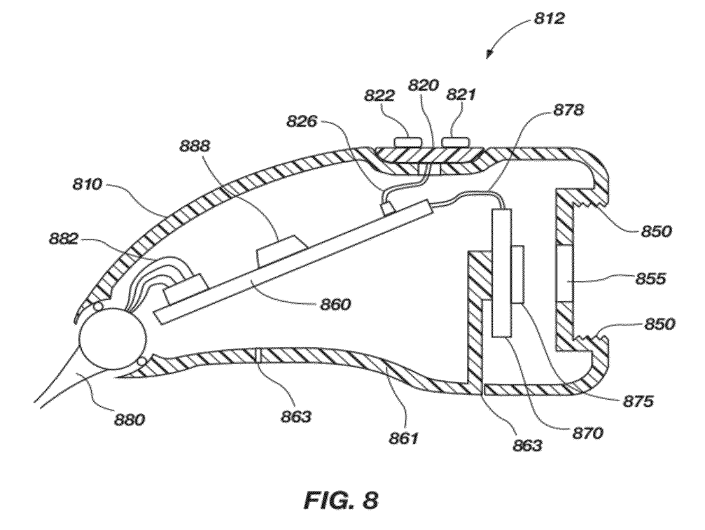

Illustrated in FIG. 8 is a cross-sectional view of an embodiment of an imaging device head 812. The imaging device head 812 may comprise a housing 810 made of a suitably rigid material such as plastic or metal. The housing 810 may be sealed against fluids and gases so as to protect the internal circuitry and provide a suitable surface for sterilization and renewal. The imaging device head 812 may further comprise a user input panel 820 having buttons 821 and 822. Additional, buttons may be provided and the functionality of the buttons can be customized for a given procedure and or a given operator. The control panel 820 may be internally connected to other circuitry of the imaging device head 812 by an electrical connector 826.

As illustrated further in the embodiment of FIG. 8, the imaging device head 812 may comprise an optical mount system 850, such as a C-mount system for receiving threaded accessories, for example one inch threaded accessories. A window 855 may also be incorporated into the embodiment for facilitating the transmission of light from an optical accessory to an image sensor 875. The image sensor 875 may be mounted to a supporting printed circuit board or supportive substrate 870. An electronic connector 878 may be incorporated to electronically connect the image sensor 875 to a main circuit or main printed circuit board 860. In order to provide heat dissipation from the image sensor 875 and other circuitry, a heat sink 861 may be provided. The heat sink 861 may be physically connected to the image sensor 875 and it may also be connected to the housing 810, such that heat energy can be conducted or transferred to the external portion of the imaging device head 812. The heat sink 861 may be a neutral sensor heat sink exposed externally to ensure the camera head meets cardiac floating (CF) and body floating (BF) IEC and ISO standards. An embodiment of the heat sink 861 may be made of aluminum and have fins for added heat transfer surface area. A main wiring harness 882 may be incorporated into a wired tether 880 thereby electrically connecting the components of the imaging device head 812 to a control unit.

The imaging device head 812 may further comprise a memory 888 or memory circuit allowing the storage of data within the imaging device head 812. Data that may be stored or written into memory 888 may include an identifying serial number that uniquely identifies an imaging device. Other data that may be stored or written into memory 888 may include data such as the amount of the time the imaging device has been used, i.e., the hours of operation, or the amount of time the imaging device has been powered on. Data that may be written into memory 888 may include sterilization data or renewal data, representing the working condition of the imaging device. Data that may be stored or written into memory 888 may include data such as manufacturing date, date of last verification or quality control check, location of manufacture, i.e., may include name, city, state, street address and so forth, last control unit that the imaging device head was attached to, imaging device head diagnostic information, specific procedural settings for the imaging device head, or preferred settings for an operator or user, such as a surgeon. Data representing the above characteristics, or other indicia, of the imaging device may be recorded into memory within the imaging device.

The memory 888 may be encryption protected so as to avoid tampering or unintended use and foreseeable misuse. It should be noted that a memory may be placed anywhere in the imaging device and not just the imaging device head without departing from the scope of the disclosure. The memory 888 may comprise a permanent or semi-permanent portion allowing varying degrees of data durability.

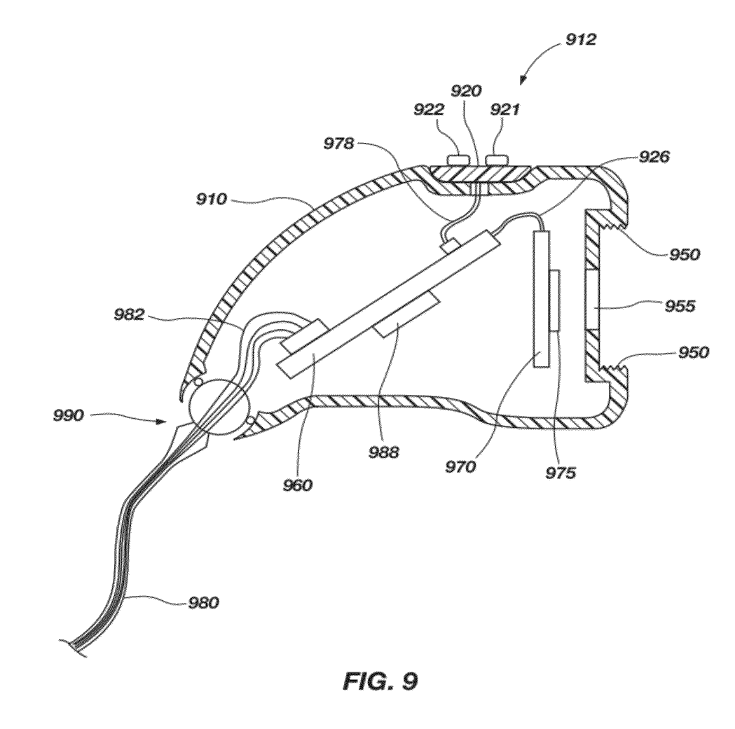

Illustrated in FIG. 9 is a cross-sectional view of an embodiment of an imaging device head 912. The imaging device head 912 may comprise a housing 910 made of a suitably rigid material such as plastic or metal. The housing 910 may be sealed against fluids and gases so as to protect the internal circuitry and provide a suitable surface for sterilization and renewal. The imaging device head 912 may further comprise a user input panel 920 having buttons 921 and 922. Additional, buttons maybe provided and the functionality of the buttons can be customized for a given procedure and or a given operator. The control panel 920 may be internally connected to other circuitry of the imaging device head 912 by an electrical connector 926.

As illustrated further in the embodiment of FIG. 9, the imaging device head 912 may comprise an optical mount system 950, such as a C-mount system for receiving threaded accessories, for example one inch threaded accessories. A window 955 may also be incorporated into the embodiment for facilitating the transmission of light from an optical accessory to an image sensor 975. The image sensor 975 may be mounted to a supporting printed circuit board or supportive substrate 970. An electronic connector 978 may be incorporated to electronically connect the image sensor 975 to a main circuit or main printed circuit board 960. In order to provide heat dissipation from the image sensor 975 and other circuitry, a heat sink may be provided, similar to the heat sink provided in FIG. 8. The heat sink may be physically connected to the image sensor 975 and it may also be connected to the housing 910, such that heat energy can be conducted or transferred to the external portion of the imaging device head 912. A main wiring harness 982 may be incorporated into a wired tether 980 thereby electrically connecting the components of the imaging device head 912 to a control unit.

The imaging device head 912 may further comprise a memory 988 or memory circuit allowing the storage of data within the imaging device head 912. Data that may be stored or written into memory 988 may include an identifying serial number that uniquely identifies an imaging device. Other data that may be stored or written into memory 988 may include data such as the amount of the time the imaging device has been used, i.e., the hours of operation, or the amount of time the imaging device has been powered on. Data that may be stored or written into memory 988 may include data such as manufacturing date, date of last verification or quality control check, location of manufacture, i.e., may include name, city, state, street address and so forth, last control unit that the imaging device head was attached to, imaging device head diagnostic information, specific procedural settings for the imaging device head, or preferred settings for an operator or user, such as a surgeon. Data representing the above characteristics, or other indicia, of the imaging device may be recorded into memory within the imaging device.

The memory 988 may be encryption protected so as to avoid tampering or unintended use and foreseeable misuse. It should be noted that a memory may be placed anywhere in the imaging device and not just the imaging device head without departing from the scope of the disclosure. The memory 988 may comprise a permanent or semi-permanent portion allowing varying degrees of data durability.

The imaging device head 912 may comprise a ball joint 990 with a corresponding seal and socket, thereby providing increased mobility between the housing 910 and the tether 980 during articulation of the imaging device by an operator or user.

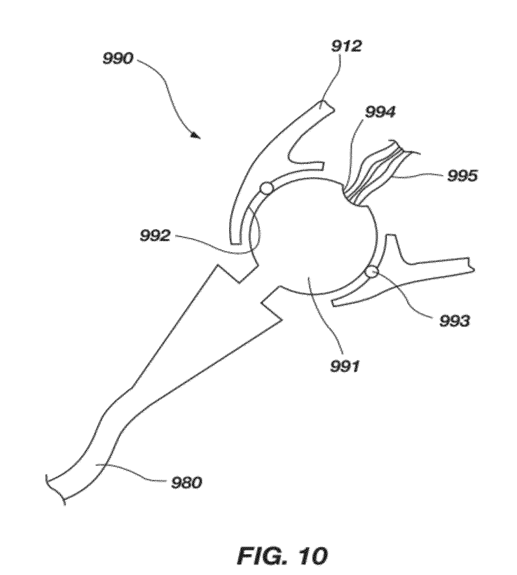

With reference primarily to FIG. 10, an embodiment of an imaging device ball joint 990 will be discussed in further detail. FIG. 10 is illustrative of a cross-sectional view of a ball joint 990, which provides greater freedom of articulation for an operator when moving the imaging device head 912 relative to the wiring tether 980. The ball joint 990 may comprise a substantially spherical rotatable portion or ball 991. The ball 991 may be configured to mechanically operate in communication with a corresponding socket 992, such that the ball 991 may substantially freely rotate while being retained within the socket 992. A seal may be provided withing the ball joint 990 by the inclusion of a seal ring 993. The seal ring 993 may also provide mechanical resistance within the ball joint 990. The ball 991 may further include an opening 994 therethrough allowing wiring 995 to pass through the ball joint 990.

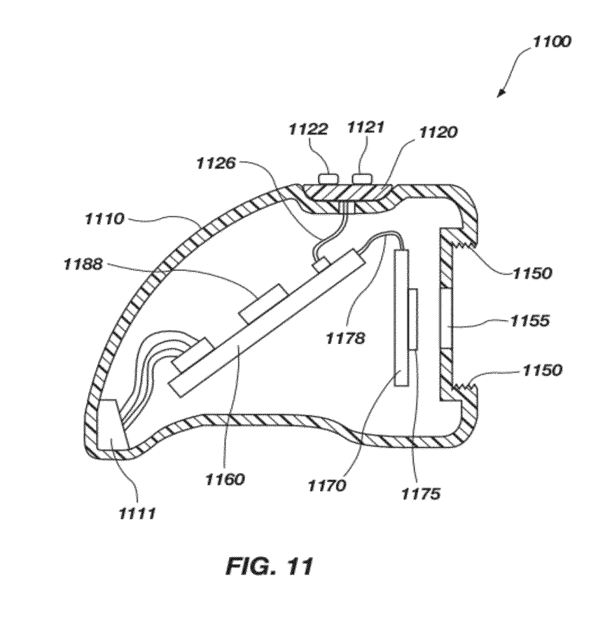

With reference to FIG. 11, an embodiment of an imaging device 1100 comprising wireless transmission functionality will be discussed. A cross-sectional view of an embodiment of an imaging device head 1112 is shown in FIG. 11. The imaging device head 1112 may comprise a housing 1110 made of a suitably rigid material such as plastic or metal. The housing 1110 may be sealed against fluids and gases so as to protect the internal circuitry and provide a suitable surface for sterilization and renewal. The imaging device head 1112 may further comprise a user input panel 1120 having buttons 1121 and 1122. Additional, buttons may be provided and the functionality of the buttons can be customized for a given procedure and or a given operator. The control panel 1120 may be internally connected to other circuitry of the imaging device head 1112 by an electrical connector 1126. The imaging device head 1112 may communicate with a control unit by way of wireless transmissions such as Wifi, infrared, bluetooth etc. Other forms of wireless non-tethered connectivity may also be used for providing communication between the imaging device head 1112 and the control unit, including but not limited to, radio frequency from any available spectrum, infrared of any configuration, ultrasonic, and optical. As illustrated further in the embodiment of FIG. 11, the imaging device head 1112 may comprise an optical mount system 1150, such as a C-mount system for receiving threaded accessories, for example one inch threaded accessories. A window 1155 may also be incorporated into the embodiment for facilitating the transmission of light from an optical accessory to an image sensor 1175. The image sensor 1175 may be mounted to a supporting printed circuit board or supportive substrate 1170. An electronic connector 1178 may be incorporated to electronically connect the image sensor 1175 to a main circuit or main printed circuit board 1160. The circuitry of the imaging device head 1112 may electrically be connected to a wireless transceiver 1111 for transmitting and receiving data from a wirelessly configured control unit as illustrated in FIG. 3.

The imaging device head 1112 may further comprise a memory 1188 or memory circuit allowing the storage of data within the imaging device head 1112. Data that may be stored or written into memory 1188 may include an identifying serial number that uniquely identifies an imaging device. Other data that may be stored or written into memory 1188 may include data such as the amount of the time the imaging device has been used, i.e., the hours of operation, or the amount of time the imaging device has been powered on. Data that may be stored or written into memory 1188 may include data such as manufacturing date, date of last verification or quality control check, location of manufacture, i.e., may include name, city, state, street address and so forth, last control unit that the imaging device head was attached to, imaging device head diagnostic information, specific procedural settings for the imaging device head, or preferred settings for an operator or user, such as a surgeon. Data representing the above characteristics, or other indicia, of the imaging device may be recorded into memory within the imaging device.

The memory 1188 may be encryption protected so as to avoid tampering or unintended use and foreseeable misuse. It should be noted that a memory may be placed anywhere in the imaging device and not just the imaging device head without departing from the scope of the disclosure. The memory 1188 may comprise a permanent or semi-permanent portion allowing a varying degrees of data durability.

It will be appreciated that the ball joint illustrated in FIGS. 9 and 10 may be used by any embodiment of the disclosure without departing from the spirit or scope of the disclosure. Thus, for example, the ball joint 990 may be used with imaging device head 712, 812, 912, or 1112. Similarly, it will be appreciated that the heat sink 861 (illustrated in FIG. 8) may be used by any embodiment of the disclosure without departing from the scope of the disclosure.

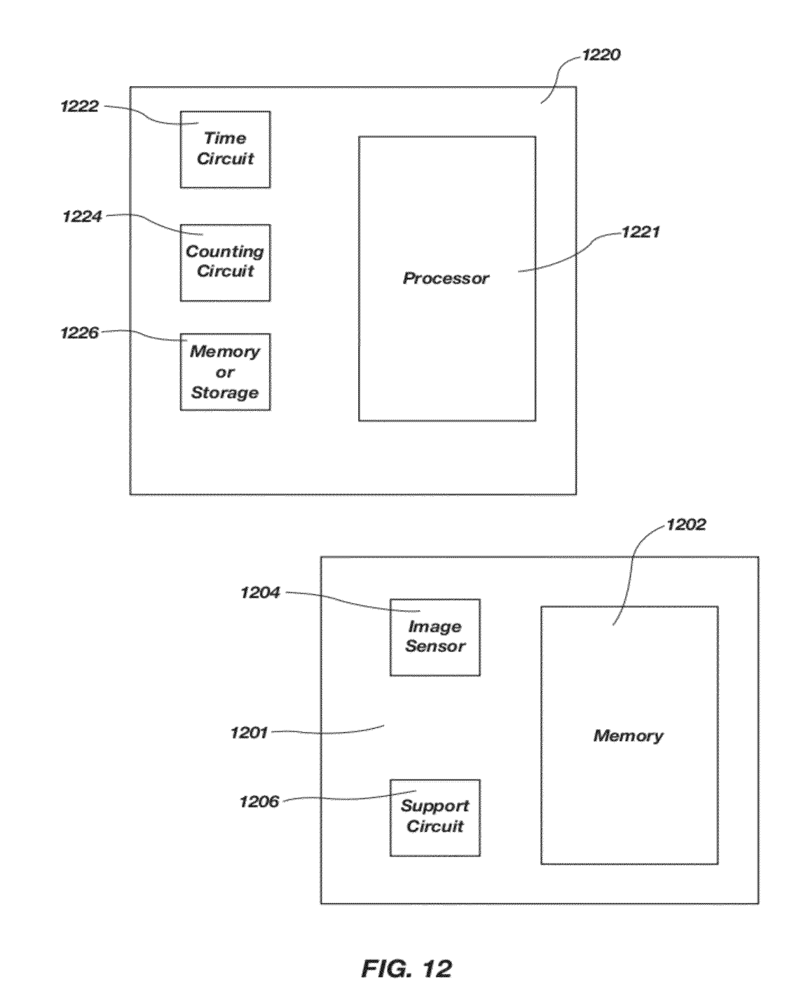

Referring now to FIG. 12 an embodiment of a system for acquiring imagery in a sterilized environment will be discussed. The system may comprise an imaging device 1201 having a memory 1202, an image sensor 1204, and supporting circuitry 1206. The system may further comprise and control unit 1220 having a processor 1221, time circuit or realtime clock 1222, a counting or incrementing circuit 1224 and a control unit memory 1226. The components will generally be provided in a housing, but are shown hear in block diagram form for simplicity and discussion purposes. It is contemplated that any of the above circuits can operate from either a control unit or an imaging device.

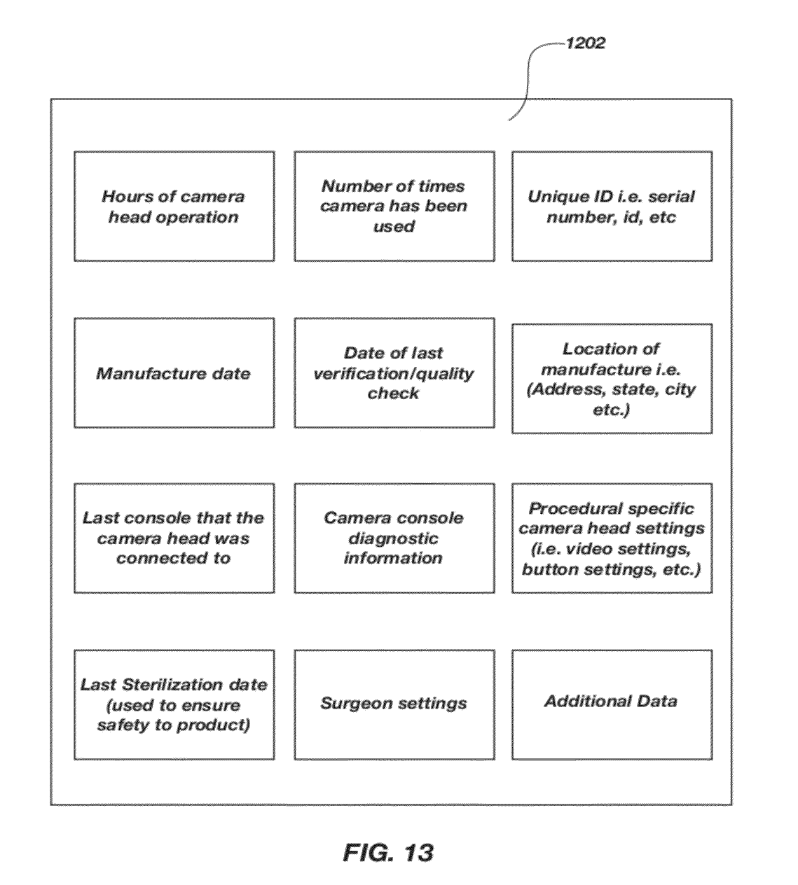

As can be seen in FIG. 13 the memory 1202 of the imaging device 1201 may comprise the following arrays of data storage:

a. Hours of camera head operation;

b. Number of times camera has been used;

c. Unique identification i.e. serial number, id, etc.;

d. Manufacture date;

e. Date of last verification/quality check;

f. Location of manufacture i.e. (Address, state, city etc.);

g. Last console that the camera head was connected to;

h. Camera console diagnostic information;

I. Procedural specific camera head settings (i.e. video settings, button settings, etc.);

j. Last Sterilization date (used to ensure safety to product); and

k. Surgeon or user settings.

Additional data may be stored within the memory 1202 that would enhance the imaging device and is considered to be within the scope of the disclosure.

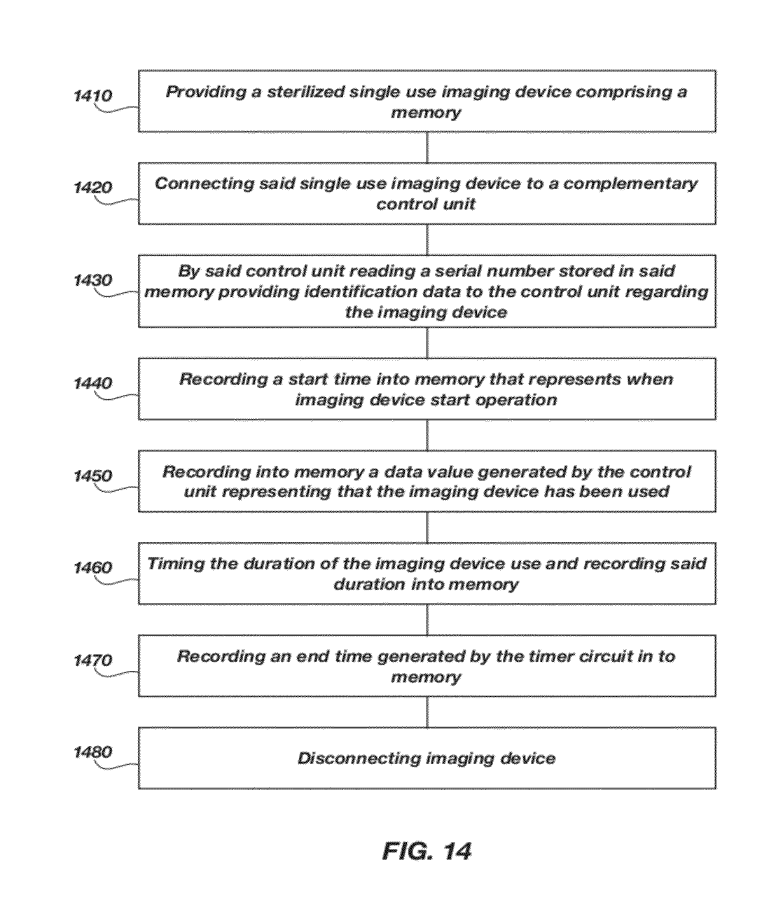

With reference to FIG. 14, a method of using an imaging system consistent with the embodiments disclosed herein will be discussed. In use, a sterilized single use imaging device 1201 will be provided that may comprise memory 1202 at 1410. At 1420 a user may connect the single use imaging device 1201 to a complementary control unit 1220 both electronically and physically. At 1430 the control unit 1220 may initiate a process of reading memory 1202 and registers the serial number of the imaging device 1201. At 1440 the system causes a value to be recorded into memory 1202 indicating that the imaging device 1201 has been used. At 1450 the system records into memory 1202 the date and time the imaging device 1201 is connected to the control unit 1220. At 1460 a timing process is initiated by the control unit from the base line time recorded at 1450 and tracks or times the duration that the imaging device 1201 is used and the duration is recorded into memory 1202 at 1470. After use, the imaging device 1201 is disconnected from the control unit 1220 at 1480 and then discarded for renewal or reclamation.

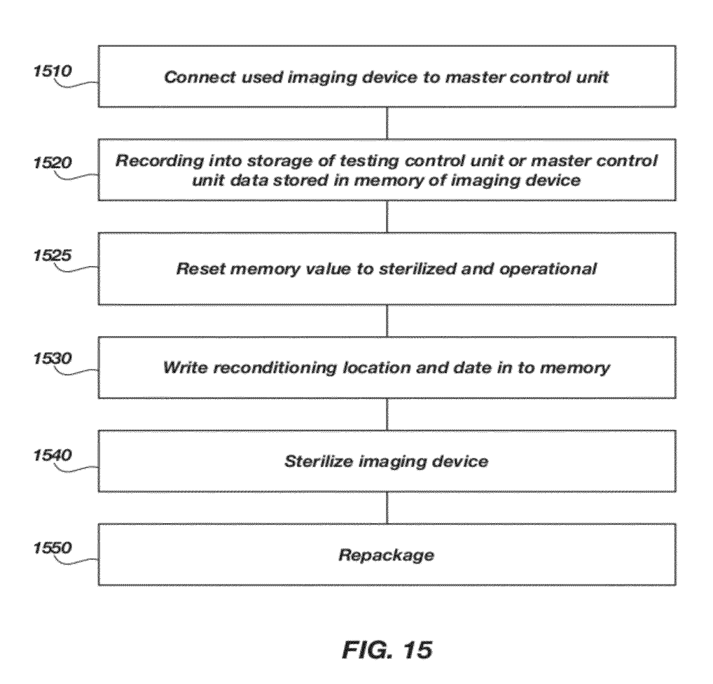

Referring now to FIG. 15, a method of renewing and reclaiming a single use imaging device 1201 will be discussed. At 1510 the imaging device 1201 may be connected to a testing control unit or a master control unit. At 1520 the testing control unit or master control unit causes the data stored in memory 1202 to be recorded into storage on the testing control unit or master control unit as stored, in order for the specific imaging device 1201 to be renewed. At 1525 a value is placed in memory 1202 indicating that the imaging device has been renewed and is ready for use such that when connected to another control unit for use it will operate. The location and date of the renewal may then be recorded into memory 1202 at 1530. At 1540 the imaging device 1201 can be sterilized and (at 1550) placed in a protective sterilized package.

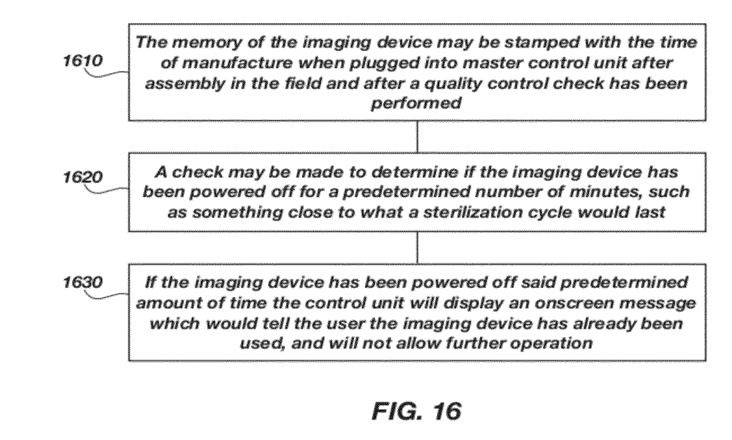

With reference to FIG. 16 an alternative embodiment of a method of use will be discussed illustrating safety settings of the embodiment. At 1610 the memory imaging device head may be stamped with time of manufacture when it is plugged into the master control unit or master console after assembly in the field, i.e., in an operating room, and after a quality control check has been performed. At 1620 a check may be made to determine if the imaging device has been powered off for a predetermined number of minutes, such as a time frame that is close to what a typical sterilization cycle would last. At 1630, if the imaging device has been powered off the predetermined amount of time the control unit will display an onscreen message telling the user the imaging device has already been used, and will not allow further operation, such that no image will be produced through video feed. This feature will ensure the imaging device, i.e., the camera, will not be used more than one time per sterilization cycle. This feature also protects the patient and the doctor from an invalid or unsafe use and foreseeable misuse.

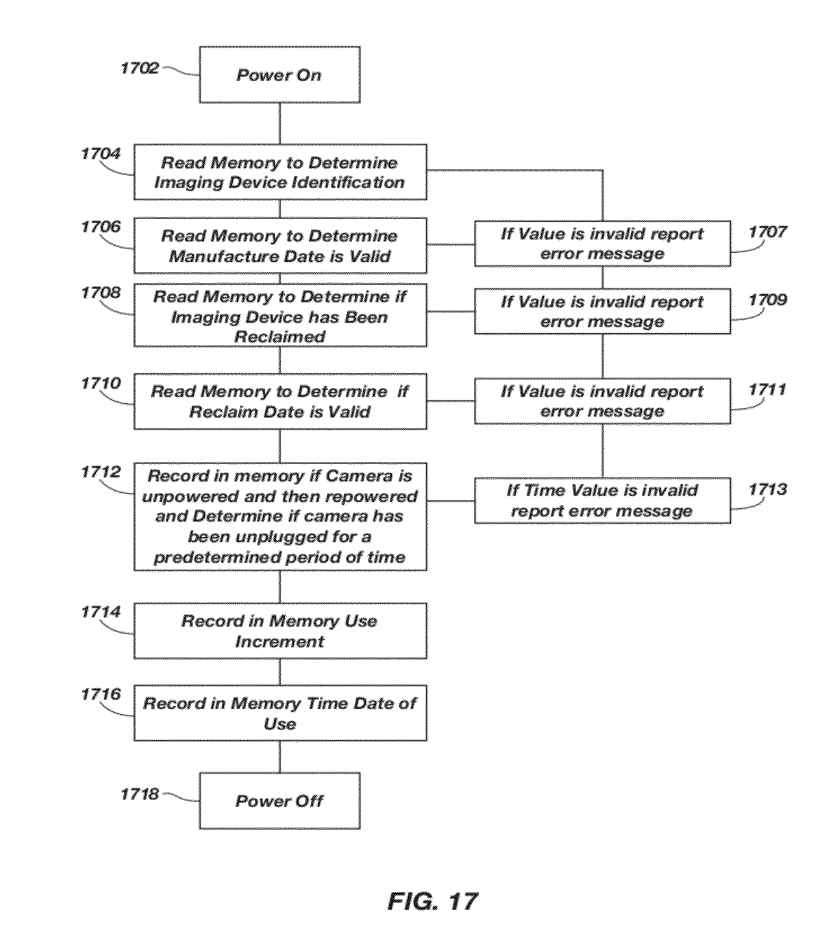

Referring to FIG. 17 an embodiment of a method of use will be discussed. During use, an imaging device may be connected to a control unit. Upon connection, an electronic communication connection is formed between the imaging device and the control unit. At 1702 the imaging device may be powered on by power supplied by the control unit. At 1704 a processor in the control unit may cause data regarding imaging device identification that may be stored in a memory within the imaging device to be read. At 1706 a processor in the control unit may cause data regarding the manufacturing date of the imaging device to be read from memory within the imaging device. The processor in the control unit may then compare the data to a predetermined data value range. At 1707 an error message may be displayed if the read data is outside the predetermined data value range and the imaging device will be stopped from operating. At 1708 a processor in the control unit may cause data regarding the reclamation of the imaging device to be read from memory within the imaging device. The data regarding reclamation of the imaging device may include data representing whether or not the imaging device has been previously used. The processor may then compare the data to a predetermined data value range. At 1709 an error massage may be displayed if the read data is outside the predetermined data value range and the imaging device will be stopped from operating. At 1710 a processor in the control unit may cause data regarding the reclamation date of the imaging device to be read from memory within the imaging device. The processor may then compare the data to a predetermined data value range. At 1711 an error massage may be displayed if the read data is outside the predetermined data value range and the imaging device will be stopped from operating. At 1712 a processor in the control unit may cause usage information of the current procedure to be monitored to note whether imaging device has been unpowered for a predetermined period of time and then re-powered. If this condition occurs it is possible that the imaging device has been tampered with or that an attempt has been made to sterilize the imaging device and use it a second time. The predetermined period of time may correspond to the amount of time a typical sterilization process would normally take. The processor then compares the data to a predetermined data value range. At 17013 an error massage may be displayed if the data read is outside the predetermined data value range and the imaging device will be stopped from operating. At 1714 a processor in the control unit may cause a value to be placed in memory in the imaging device indicating that the imaging device has been used. At 1716 a processor in the control unit may cause the date and time of use to be recorded in memory in the imaging device. Additional information may be recorded into the memory of the imaging device such as, for example, duration of use, procedure settings, and user settings and any other data suitable for recording to memory. The imaging device may be disconnected from the control unit and thereby powered off at 1718.

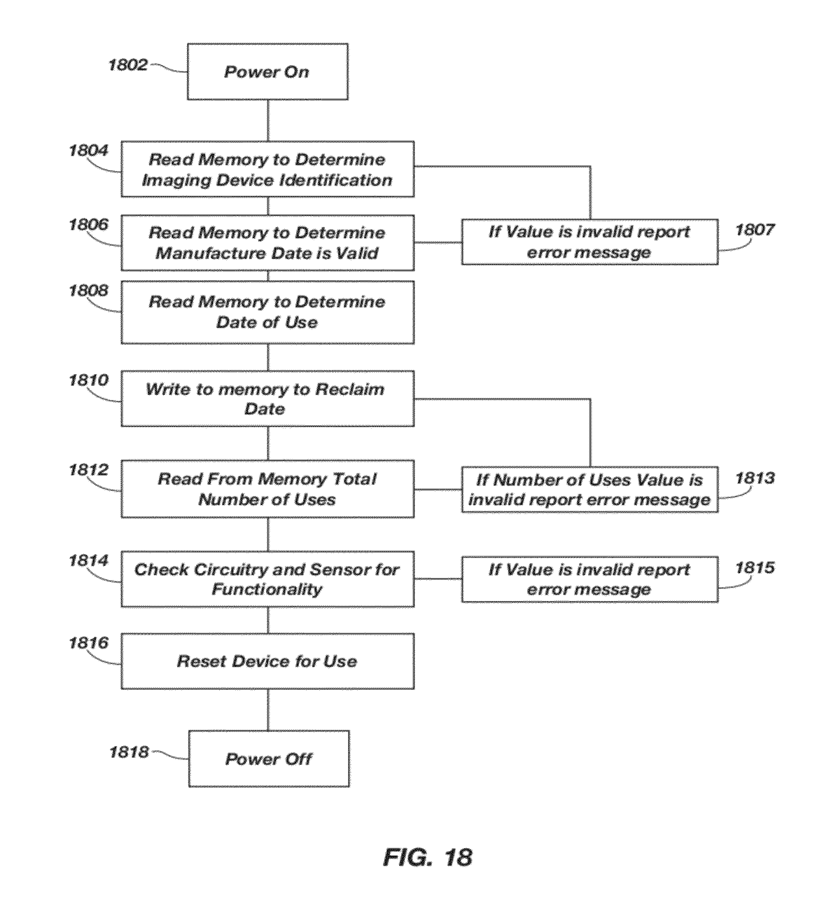

Referring now to FIG. 18 a method of reclaiming an image device after use will be discussed. It should be noted that a single use imaging device may comprise the durability to be used a plurality of times, however sterilization requirements may prevent an imaging device from being used more than once without a process for reclaiming the imaging device, thereby returning it to a sterilized condition. A method of reclamation for an imaging device may comprise the process of powering on the imaging device at 1802, when the imaging device is electrically connected to a control unit. At 1804 a processor in the control unit may cause data representing identification information for the imaging device to be stored in storage in the control unit. A control unit may be a master control unit configured for reclaiming the imaging devices. The master control unit may track a plurality of imaging devices thereby keeping a catalog of associated information such as use and condition of the device or devices. At 1806 a processor in the control unit may cause that data representing a manufacturing date to be read and compared to a predetermined value or range of values. If the read data is out of the predetermined range value, an error report may be issued at 1807. At 1808 a processor in the control unit may cause data representing use data written in memory of the imaging device to be read and recorded into storage in the control unit. At 1810 a processor may cause data representing a date and time of reclamation to be recorded into memory in the imaging device. At 1812 a processor in the control unit may cause that data representing the number of uses of the imaging device to be read and recorded into storage in the control unit. The processor may compare the read data to a predetermined value or range of values to determine whether the imaging device is fit for continued use. If the predetermined value is exceeded an error message may be displayed (at 1813) and the imaging device may be retired. At 1814 a processor in the control unit may initiate a test or quality control check of all the circuitry in the imaging device to ensure that the device is functional. At 1815 it may be determined that the imaging device failed the quality control check and an error massage may be displayed. At 1816 the imaging device can be reset for use. The resetting process may comprise writing data to the memory of the imaging device indicating that the imaging device has been reclaimed and sterilized. At 1816 the device may be disconnected from the control unit and physically sterilized and repackaged.

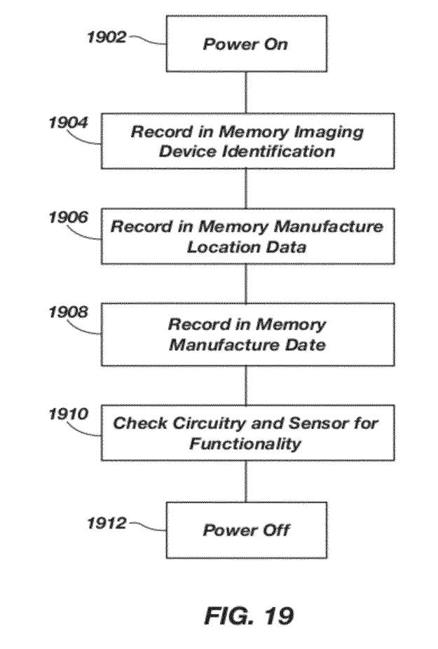

With reference primarily to FIG. 19 an embodiment of a method for making an imaging device having memory therein for use in a sterilized environment will be discussed. At 1902 an imaging device may be powered on upon being connected to a control unit. The control unit may be a master control unit configured for the manufacturing process. At 1904 a processor in the control unit may cause that data representing an identification serial number for the imaging device to be written into memory of the imaging device. At 1906 a processor in the control unit may cause that data representing the location of manufacture be recorded to memory in the imaging device. At 1908 a processor may cause that data representing the date of manufacture may be recorded into memory on the imaging device. At 1910 a processor in the control unit may initiate a test or quality control check of all the circuitry in the imaging device to ensure that the device is functional. At 1912 the imaging device may be unplugged from the control and sterilized for packaging.

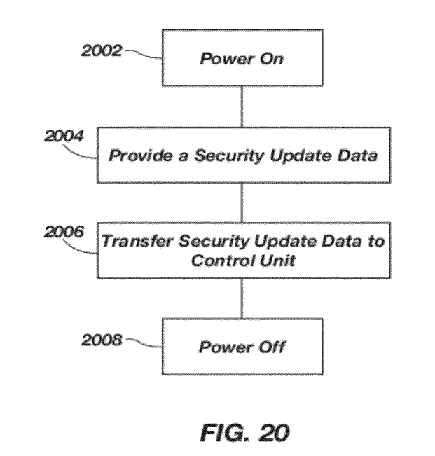

Referring to an embodiment illustrated in FIG. 20, a system having a security code or some other means of identifying, and validating for use, an imaging device by a control unit, in order to verify that the imaging device is authorized for use will now be described. A validating security code or procedure of validation may be distributed to control units from a central database over the internet, by direct transfer from portable storage device such as USB device containing memory, another computer, or other storage device. With reference to FIG. 20 an embodiment of a method for providing updates with in a medical imaging system will be discussed. At 2002 a control unit may be powered on to receive a security update. At 2004 security update data may provided comprising validation codes that correspond to imaging devices to be connected to the control unit. Such validation codes may enable the system to insure that users of the system may be prevented from using imaging devices that have been selected for non-use by a manufacturer or distributor. Selection criteria for non-use may include safety considerations, recall considerations, anti counterfeit measures, and sales and contract considerations. At 2006 the data may be transferred into storage or memory of the control unit in order to provide that data for later comparison to security codes provided by imaging devices. It is within the scope of this disclosure to include all means for transferring data, including but not limited to, transmission over a network, transfer via on site transmission from a storage medium that is portable, such as a disk, memory drive, or short distance wireless transmission. At 2008 the system may be powered off.

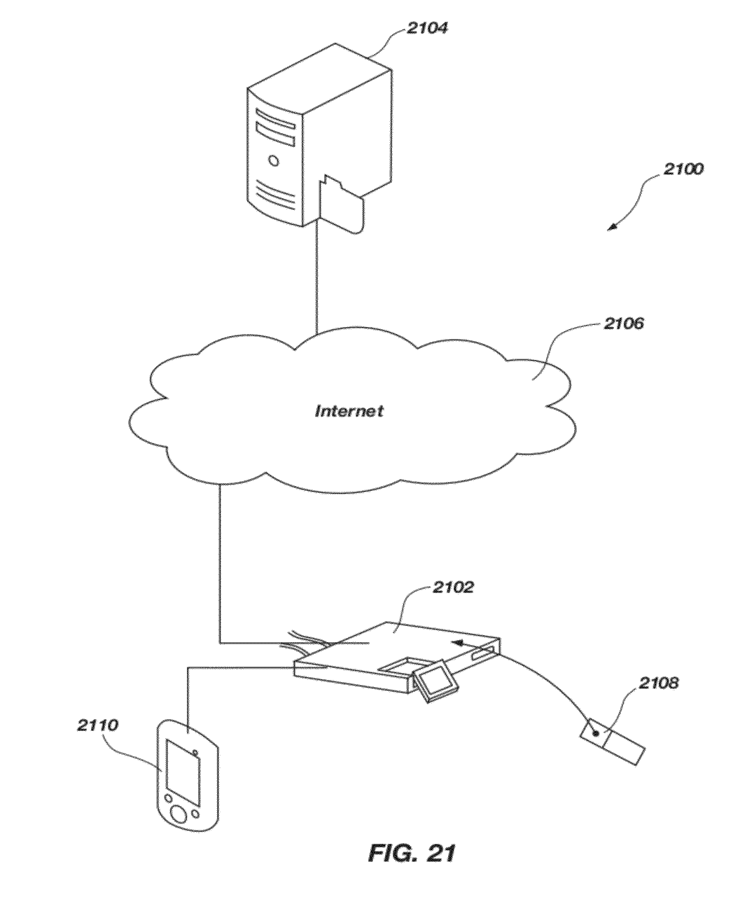

With reference primarily to FIG. 21 an embodiment of an imaging system have the feature of updating data will be discussed. An imaging system 2100 may comprise a control unit 2102 and a data server 2104. The control unit 2106 may be electronically in communication with the data server 2104 over a network such as the internet 2106. The control unit 1202 may receive update data over the internet 2106 from data server 2104. The control unit 2102 may also receive update data directly from a memory transfer device 2108 such as a memory stick, thumb drive, jump drive, hard drive, optical disk to name a few. The control unit 2102 may also receive update data from another computer or portable device 2110 such as a PDA or laptop that is presented to the control unit 2102 on site. Data transfer may be made with a physical connection and or by a wireless transfer of data.

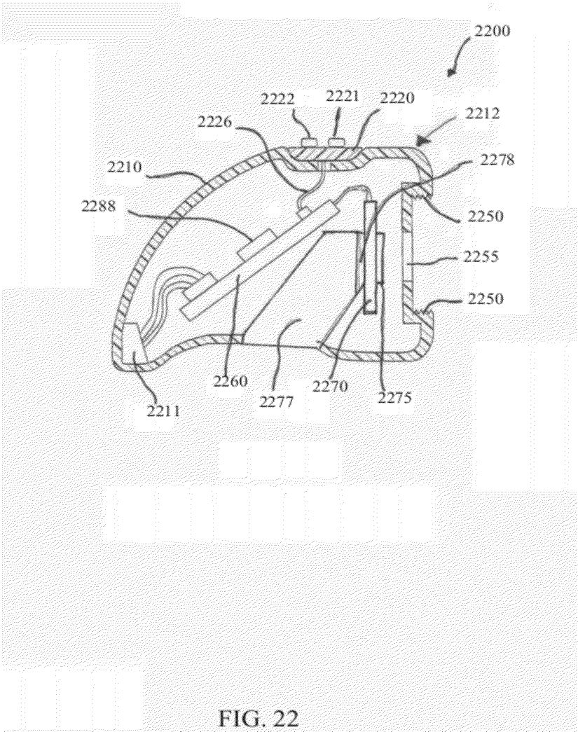

With reference to FIG. 22, an embodiment of an imaging device 2200 comprising a heat sink 2277 having a thermal pad 2278 will be discussed. A cross-sectional view of an embodiment of an imaging device head 2212 is shown in FIG. 22. The imaging device head 2212 may comprise a housing 2210 made of a suitably rigid material such as plastic or metal. The housing 2210 may be sealed against fluids and gases so as to protect the internal circuitry and provide a suitable surface for sterilization and renewal. The imaging device head 2212 may further comprise a user input panel 2220 having buttons 2221 and 2222. Additional, buttons may be provided and the functionality of the buttons can be customized for a given procedure and/or a given operator. The control panel 2220 may be internally connected to other circuitry of the imaging device head 2212 by an electrical connector 2226. The imaging device head 2212 may communicate with a control unit by way of wireless transmissions such as Wifi, infrared, bluetooth etc. Other forms of wired and wireless non-tethered connectivity may also be used for providing communication between the imaging device head 2212 and the control unit, including but not limited to, hard wired, radio frequency from any available spectrum, infrared of any configuration, ultrasonic, and optical.

As illustrated further in the embodiment of FIG. 22, the imaging device head 2212 may comprise an optical mount system 2250, such as a C-mount system for receiving threaded accessories, for example one inch threaded accessories. A window 2255 may also be incorporated into the embodiment for facilitating the transmission of light from an optical accessory to an image sensor 2275. The image sensor 2275 may be mounted to a supporting printed circuit board or supportive substrate 2270. An electronic connector 2278 may be incorporated to electronically connect the image sensor 2275 to a main circuit or main printed circuit board 2260. The circuitry of the imaging device head 2212 may electrically be connected to a wireless transceiver 2211 for transmitting and receiving data from a wirelessly configured control unit as illustrated in FIG. 3.

The imaging device head 2212 may further comprise a memory 2288 or memory circuit allowing the storage of data within the imaging device head 2212. Data that may be stored or written into memory 2288 may include an identifying serial number that uniquely identifies an imaging device. Other data that may be stored or written into memory 2288 may include data such as the amount of the time the imaging device has been used, i.e., the hours of operation, or the amount of time the imaging device has been powered on. Data that may be stored or written into memory 2288 may include data such as manufacturing date, date of last verification or quality control check, location of manufacture, i.e., may include name, city, state, street address and so forth, last control unit that the imaging device head was attached to, imaging device head diagnostic information, specific procedural settings for the imaging device head, or preferred settings for an operator or user, such as a surgeon. Data representing the above characteristics, or other indicia, of the imaging device may be recorded into memory within the imaging device.

The memory 2288 may be encryption protected so as to avoid tampering or unintended use and foreseeable misuse. It should be noted that a memory may be placed anywhere in the imaging device and not just the imaging device head without departing from the scope of the disclosure. The memory 2288 may comprise a permanent or semi-permanent portion allowing a varying degrees of data durability.

In order to provide protection to a user against electrical contact an embodiment may be electrically sealed or electrically insulated from a user. It will be appreciated that a user may be a surgeon, a surgical assistant, a technician, a patient, or any other person who may come in contact with the device. Such insulation may provide for heat transfer while at the same time electrically insulating the user from the electronics of the camera head 2200. Illustrated in FIG. 22 is a heat sink 2277 having a thermal pad 2278. The thermal pad 2278 may be configured to allow the transfer of thermal energy from circuit board 2270 and image sensor 2275 to the heat sink 2277, while electrically insulating the components from the heat sink 2277, thereby dissipating heat generated by the circuitry without risk of electrical contact with the user. The thermal pad 2278 may be substantially rigid or may be deformable. The thermal pad 2278 may be configured to cover substantially all of the surface contact area between the heat sink 2277 and any heat generating circuitry. The thermal pad may be configured to cover a portion of the surface contact area between the heat sink 2277 and any heat generating circuitry. The thermal pad 2278 may be configured to cover a plurality of surface contact areas. An embodiment may comprise a plurality of thermal pads 2278 working on a single surface contact area. An embodiment may comprise a plurality of thermal pads 2278 working on a plurality of surface contact areas. An embodiment may comprise a thermal pad 2278 having areas of varying thickness configured to accommodate the structure and geometry of surrounding components. An embodiment may comprise a thermal pad 2278 comprising a plurality of materials. An embodiment may comprise a thermal pad 2278 comprising fold lines.

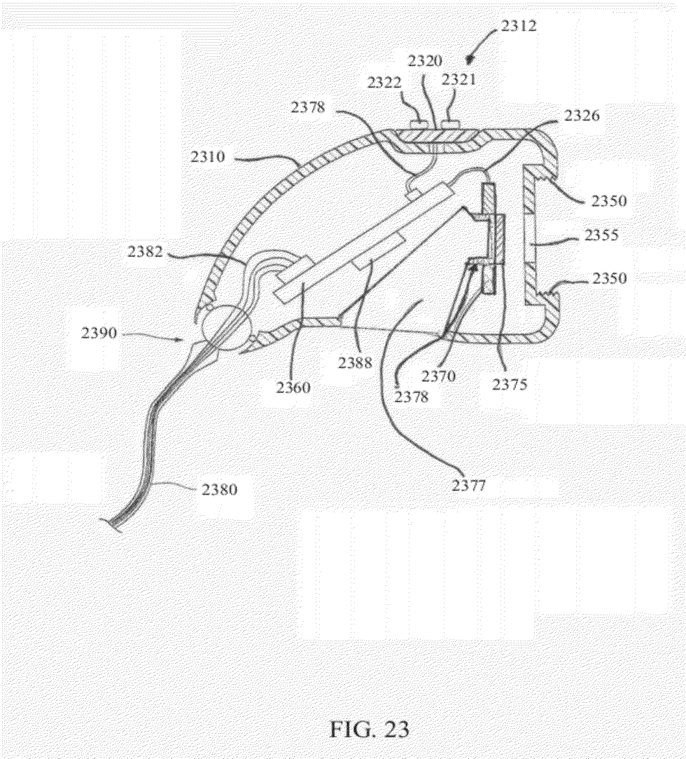

As illustrated further in the embodiment of FIG. 23, the imaging device head 2312 may comprise an optical mount system 2350, such as a C-mount system for receiving threaded accessories, for example one inch threaded accessories. A window 2355 may also be incorporated into the embodiment for facilitating the transmission of light from an optical accessory to an image sensor 2375. The image sensor 2375 may be mounted to a supporting printed circuit board or supportive substrate 2370. An electronic connector 2378 may be incorporated to electronically connect the image sensor 2375 to a main circuit or main printed circuit board 2360.

The imaging device head 2312 may further comprise a memory 2388 or memory circuit allowing the storage of data within the imaging device head 2312. Data that may be stored or written into memory 2388 may include an identifying serial number that uniquely identifies an imaging device. Other data that may be stored or written into memory 2388 may include data such as the amount of the time the imaging device has been used, i.e., the hours of operation, or the amount of time the imaging device has been powered on. Data that may be stored or written into memory 2388 may include data such as manufacturing date, date of last verification or quality control check, location of manufacture, i.e., may include name, city, state, street address and so forth, last control unit that the imaging device head was attached to, imaging device head diagnostic information, specific procedural settings for the imaging device head, or preferred settings for an operator or user, such as a surgeon. Data representing the above characteristics, or other indicia, of the imaging device may be recorded into memory within the imaging device.

The memory 2388 may be encryption protected so as to avoid tampering or unintended use and foreseeable misuse. It should be noted that a memory may be placed anywhere in the imaging device and not just the imaging device head without departing from the scope of the disclosure. The memory 2388 may comprise a permanent or semi-permanent portion allowing a varying degrees of data durability.

FIGS. 24-29 illustrate schematic views of embodiments of a data distribution and transmission system, apparatus and method. Referring to FIG. 24, in the embodiment illustrated an imaging sensor 2400 outputs image data either as a single image or as video. A digital sensor outputting image data, such as a CMOS sensor 2402, will not need further processing from an analog/digital converter 2408. An imaging sensor that outputs analog data such as CLDs 2404 and CCDs 2406 may also be used. In such cases, an analog/digital converter 2410 may be used to convert the analog output of the sensor into computer useable digital data. In the embodiment, horizontal sync data and vertical sync data may be inserted into the data stream marking the video data, such that it can be reassembled by a computer after transmission. Such reassembly may take place within a corresponding camera control unit after it was divided within the imaging device. In order to provide as much bandwidth as possible for data transmission through a medium having a plurality of channels therein, the data stream may be divided or split into a plurality of sub-data streams such that every channel in the medium is used to a predetermined level. In the embodiment, a cable may be used and in other embodiments wireless transmission may be used. A cable may be configured such as an HDMI cable, or may be of proprietary configuration. If a Type B HDMI cable is used, for illustration purposes, it may provide 29 pins comprising 7 or 8 differential pairs for data transmission. In such a case it may be desirable to split the video data into 7 or 8 sub-data streams in order to maximize throughput. As illustrated in FIG. 25 a circuit may be used to split the data. Such a circuit may be a field programable gate array 2430 that can be permanently configured or may be configured on the fly remotely by appropriate circuitry 2450.

The field programable array 2430 may be configured for converting a parallel bus into 7 or 8 LVDS where one LVDS 2460 is a differential pair for data transmission. Several LVDSs 2460 can be combined to form a transmission line or cable 2470. The video bus and syncing information may be split between two serializer components per differential pair as discussed in more detail below. A synchronization clock signal may be divided into two and run to two serializers simultaneously. Two synched clocks may also be used. In either a single clock or two clock system on serializer will be clocked on the rising edge of the clock signal, while the other serializer may be clocked on the falling edge of the clock signal. A horizontal sync may be used as a base line signal for synchronizing the two clock signals to aid in the proper reconstruction of the waveform/data at deserialization. During reconstruction a deserializer sends video data into the processing unit where the signals may be sufficiently aligned and the processing unit can reconstruct the video. If they are not aligned then the horizontal signal may be delayed “n” clock cycles until the data is suitably aligned.

In an embodiment, an imaging sensor 2400 outputs image data as a video stream. A digital sensor outputting digital data, such as charged coupled devices configured for that purpose, may be used. An imaging sensor that outputs analog data may also be used. In such cases, an analog/digital converter 2408 may be used to convert the analog output of the sensor into computer useable digital data. Further, in an embodiment the video data may comprise horizontal sync data and vertical sync data, or meta-data, for marking the video data such that it can be divided and reassembled by a circuit or computer, such as a field programable array 2430, before and after transmission. Such reassembly may take place within a corresponding camera control unit after it was divided within the imaging device. In order to provide as much bandwidth as possible for data transmission through a medium having a plurality of channels therein, such as a data cable, the data stream may be divided or split into a plurality of sub-data streams such that every channel in the medium is used to a predetermined level somewhere near its physical capacity in many cases. A cable may be configured in a proprietary configuration having any number of channels therein. A circuit may be used to split the data. Such a circuit may be a field programable gate array 2430 that can be permanently configured or may be configured on the fly by appropriate circuitry 2450 discussed above. Reconfiguration may be done during use, maintenance or at any other interval. If reconfiguration is done on the fly, it may be done over a network as discussed above through the camera control unit.

The field programable array may be configured for converting a parallel bus into multiple LVDS 2460 where one LVDS 2460 is a differential pair for data transmission. A horizontal sync may be used as a base line signal for synchronizing the two clock signals to aid in the proper reconstruction of the waveform/data at deserialization. During reconstruction a deserializer sends video data into the processing unit where the signals may be sufficiently aligned and the processing unit can reconstruct the video. If they are not aligned, then the horizontal signal may be delayed by “n” clock cycles until the data is suitably aligned.

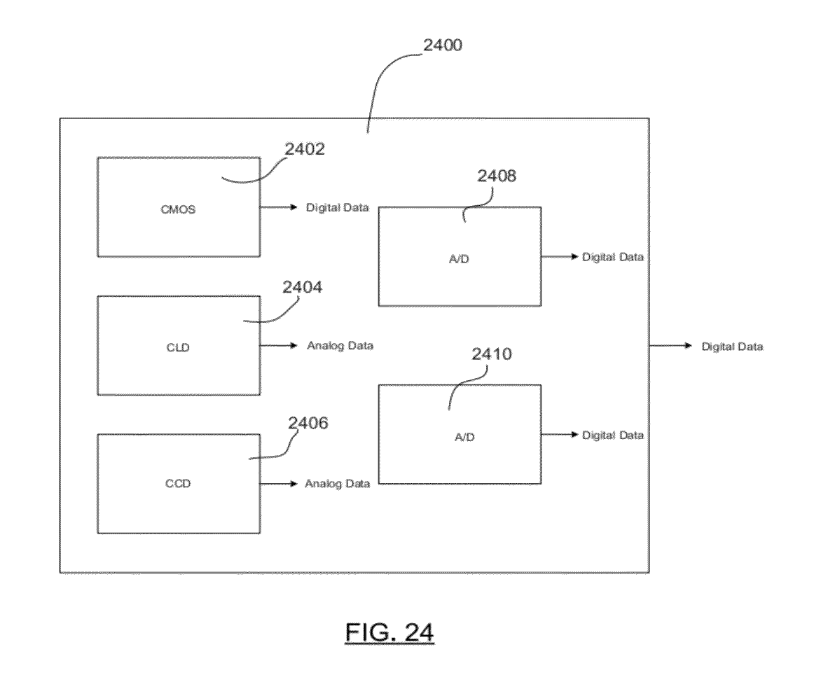

Referring now to FIG. 26 an embodiment of the disclosure will be discussed. Within an imaging system 2600 comprised of an imaging device 2602 and a control unit 2604 a large amount of data may be created during use that must be transmitted from between components. An imaging device 2602 may comprise an image sensor 2606 that generates image data during use. In certain embodiments an image sensor 2606 may generate horizontal sync and vertical sync data to aid in the usability of the image data generated by the image sensor 2606. The horizontal sync data and the vertical sync data may be used with in the system to insure data integrity. The imaging system 2600 may comprise a video data bus 2607 for transporting video data. Additionally, a clock circuit 2608 may be used to introduce timing pulses or signal into the system 2600 that can be used to regulate and coordinate the data and components within the system 2600. The clock signal may be transformed into various iterations so as to allow various components to respond correctly. For example, the clock signal may be multiplied or divided. The system 2600 may also comprise serializers 2612, 2613 in order to allow the transmission of portions of data streams that can be reconstructed by other components within the imaging system 2600. A plurality of serializers may be used to handle more data, such that video bus data may be divided among the plurality of serializers 2612, 2613. The system 2600 may comprise a cable comprising transmission lines or channels 2620 therein. The transmission channels 2620 may be transmitted as differential pairs.

With continued reference to FIG. 26, an embodiment of a method and circuitry for transmitting video data generated by and imaging sensor 2606 across a minimal number of differential pairs of transmission channels 2620 may comprise determining a number of differential pairs of transmission channels 2620 to be used; dividing video bus data into paired sub-data streams equal to the number of differential pairs of transmission channels 2620; dividing syncing information data into paired sub-syncing information data streams equal to the number of differential pairs of transmissions channels 2620; using a clock signal generated by a clock circuit 2608 to control a serializer 2612, 2613; serializing said sub-data streams and said sub-syncing information data streams into serialized data streams; transmitting said serialized data streams to a control unit 2632; deserializing with a deserializer circuit 2626 said serialized data streams into said sub-data streams and said sub-syncing information data streams; and using sync information data generated by the clock 2608 or horizontal sync circuit 2624 to properly align the video bus data using a sync logic circuit 2622 for processing by a processor 2630.

An embodiment of a method for transmitting data across a minimal number of differential pairs of transmission channels 2620 may comprise using a single deserializer 2626 to deserialize the serialized data streams into said sub-data streams and said sub-syncing information data streams.

An embodiment of a method for transmitting data across a minimal number of differential pairs of transmission channels 2620 may comprise using a plurality of serializers 2612, 2613 to serialize said sub-data streams and said sub-syncing information data streams. It will be appreciated that the embodiment may further comprise controlling the plurality of serializers with a clock signal from a clock 2608. The embodiment may further comprise dividing said clock signal by the number of serializers 2612, 2613 used.

An embodiment of a method for transmitting data across a minimal number of differential pairs of transmission channels 2620 may comprise using a plurality of deserializers 2626, 2627 to deserialize the serialized data streams into said sub-data streams and said sub-syncing information data streams. The embodiment may further comprise controlling the plurality of deserializers with a clock signal from a clock 2608. The embodiment may also comprise dividing the clock signal by the number of deserializers used.

In an embodiment of a method for transmitting data across a minimal number of differential pairs of transmission channels the number of serializers 2612, 2613 used may be equal to the number of deserializers 2626 used.

In an embodiment of a method for transmitting data across a minimal number of differential pairs of transmission channels 2620, a plurality serializers 2612 may be used with a plurality of deserializers 2626.

In an embodiment of a method for transmitting data across a minimal number of differential pairs of transmission channels 2620 a clock signal generated by a clock circuit 2608 may be used to control the plurality of serializers 2612, 2613 and deserializers 2626, 2627 and the clock signal may be divided by the sum of the plurality of serializers 2612, 2613 and deserializers 2626, 2627.

An embodiment of a method for transmitting data across a minimal number of differential pairs of transmission channels may comprise using sync information data generated by the image sensor 2602 to compare with the clock signal. The sync information data may be horizontal sync information generated by image sensor 2602 or horizontal sync circuit 2624, or vertical sync information or both horizontal and vertical sync information without departing from the scope of the disclosure.

An embodiment of a method for transmitting data across a minimal number of differential pairs of transmission channels 2620 may comprise generating video bus data and sync information data from a sensor that may be physically located within an imaging device 2602, such as the imaging device previously disclosed.

In an embodiment a of a transmitter circuit that transmits the serialized data streams, the transmission may be a short range transmission within an individual component, such that the serializer and deserializer may be physically located proximate to each other.

It will be appreciated that the sync information data may be used and compared to the clock signal generated by the clock 2608 to insure that any data has been deserialized correctly. The sync information data may be horizontal sync information or the sync information data may be vertical sync information.

An embodiment of an imaging system 2600 may comprise a control unit 2632, an imaging device 2602, a communication connection between the imaging device 2602 and the control unit 2632 such as a cable as discussed above, and an image processing circuit 2630 for transmitting data across a minimal number of differential pairs of transmission channels to the control unit 2632.

The control unit 2632 may be the control unit disclosed herein and may comprise an imaging device input as noted previously in this disclosure. The imaging device may be the imaging device disclosed herein and may comprise a housing, a memory wherein a serial number or other identifying and authenticating information may be stored for providing identification or authentication of the imaging device, an image sensor, and an opening configured to facilitate the transmission of light from optics to the image sensor.

The communication connection between the imaging device and the control unit may be a cable, wireless or other electrical communication for sending and receiving a digital signal. The image processing circuit may be as described herein above and may be used for transmitting data across a minimal number of differential pairs of transmission channels to the control unit. Thus, the image processing circuit may include one or more or all of the features disclosed herein above, such as video bus data and syncing information data that may be derived from the image sensor, a first processor for dividing video bus data into paired sub-data streams equal to the number of differential pairs of transmission channels, a clock for generating a clock signal to control a serializer, a serializer for serializing the sub-data streams and the sub-syncing information data streams into serialized data streams, a transmitter for transmitting serialized data streams, a deserializer for deserializing the serialized data streams into sub-data streams and sub-syncing information data streams, and a second processor processing the sync information data so as to properly align the video bus data.

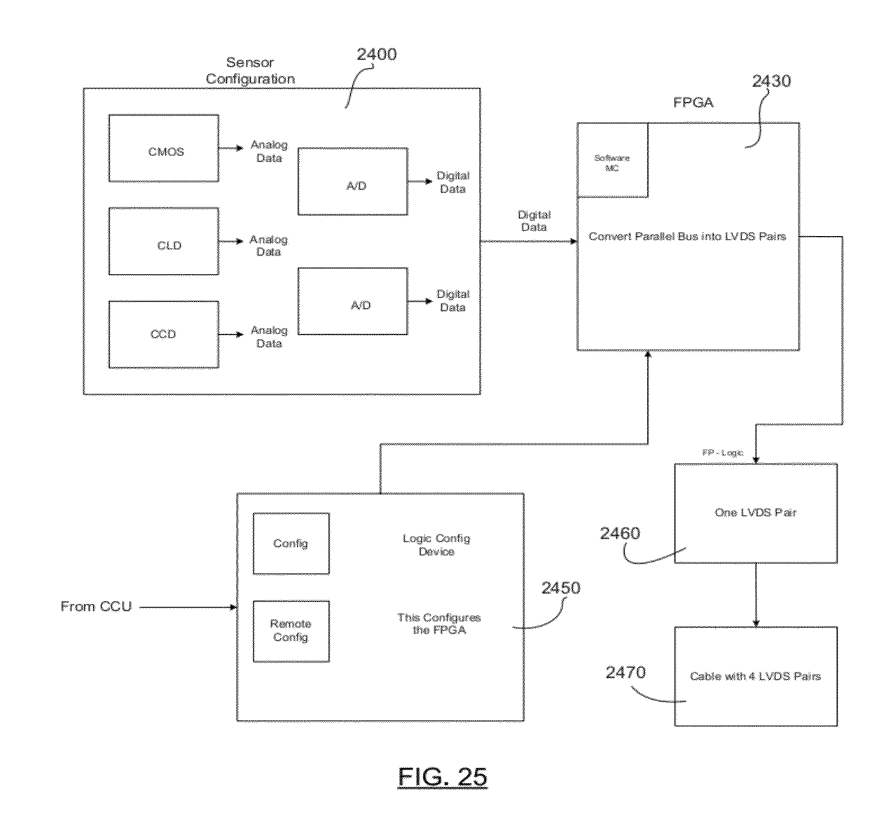

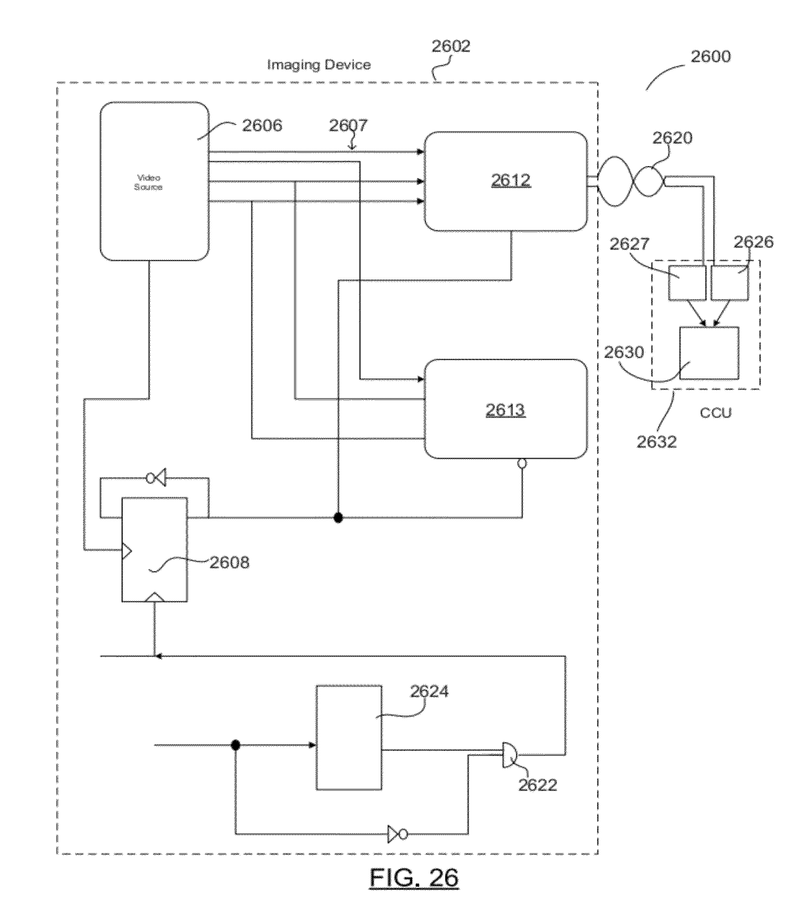

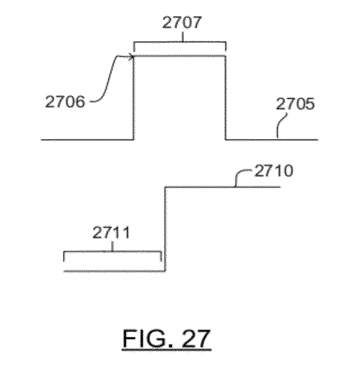

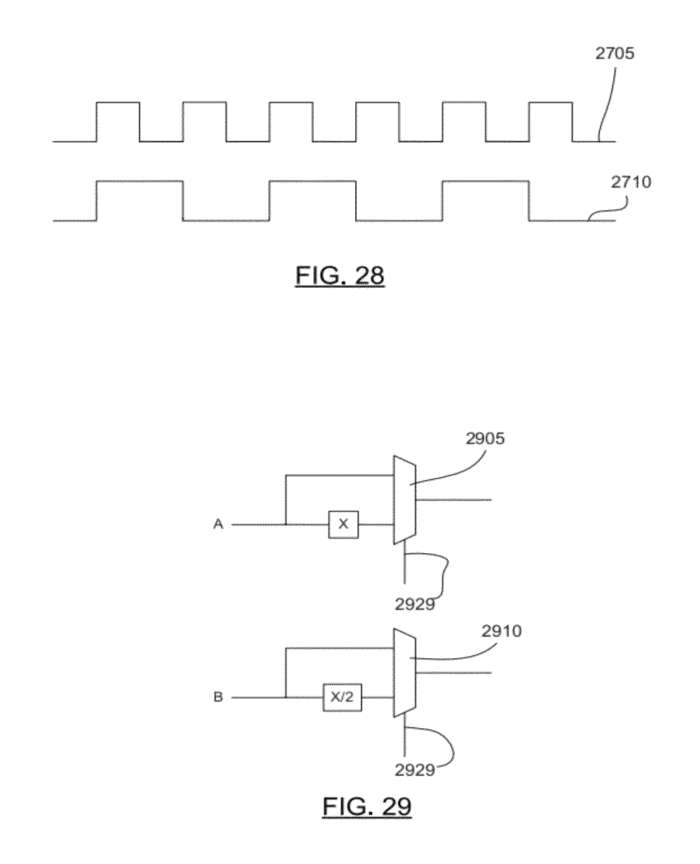

FIGS. 27-28 illustrate the use of a clock circuit to control the functions of various components the imaging system described above. As can be seen if FIG. 27, an embodiment may operate such that data to be serialized by a serializer 2612 may be processed at the rising edge 2706 of a normal clock cycle 2705 controlling a first serializer 2612. The clock cycle 2705 may correlate to the operation of a first serializer 2612, while clock cycle 2710 may correlate to the operation of a second serializer 2613. A second serializer 2613 may be configured to serialize anywhere during the pulse, as represented by the range 2711. Therefore, as can be seen in the FIG. 27, portions of relative clock cycles are depicted by ranges 2707, 2711. FIG. 28 illustrates the operation of two serializers over time, and depicts the offset that a pair of serializers may use. It is within the scope of this disclosure that more than two serializers can be used and their operation would be controlled similarly such that subsequent serializers would operate in the available clock period after prior serializers. Deserializers may work similarly to reassemble the data stream.

FIG. 28 illustrates further that clock cycles may be divided to produce differing intervals and cause components within a system to operate at differing times and rates. In an embodiment it may be desirable to divide a data stream into four sub-streams. Accordingly, a clock cycle may be divided by four so that each serializer is operating independently. Deserializers may work similarly to reassemble the data stream.

FIG. 29 illustrates the use of sync data to control the serialization of a data stream. A first data stream A may enter a first logic circuit 2905 at rate X. A second data stream B may enter a second logic circuit 2910. In an embodiment, sync data 2929 (such as horizontal sync data) generated at the image sensor can be used in both circuits to insure they operate in sync with each other.

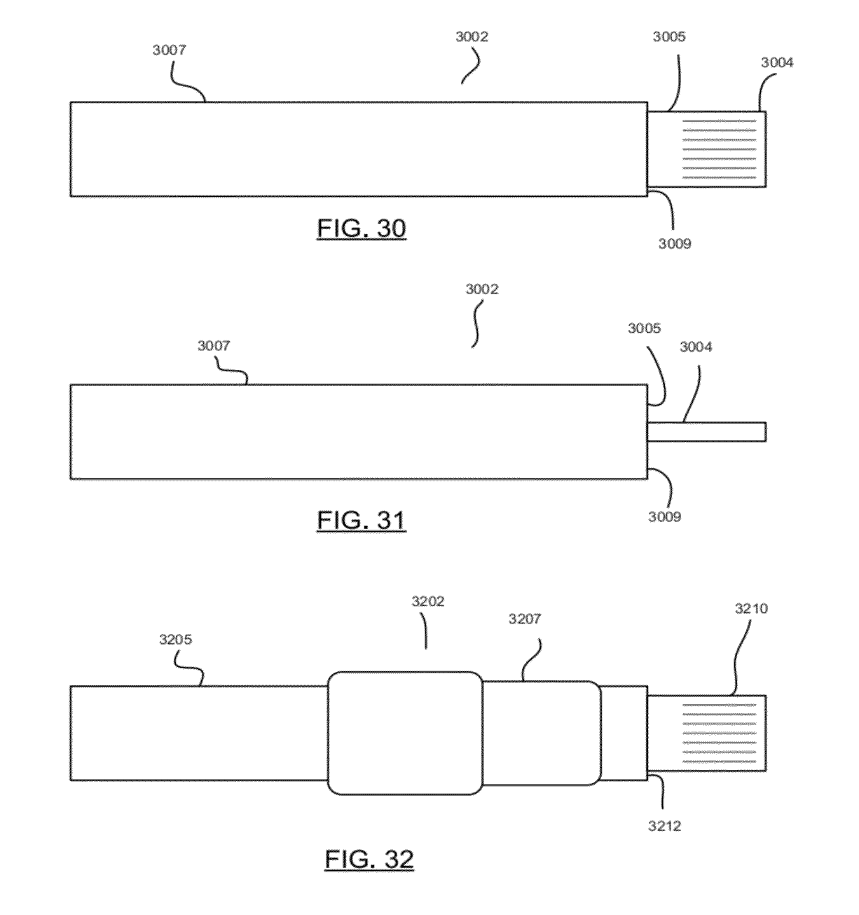

With such scrutiny placed on the exactness of the reassembly of a data stream, an embodiment may comprise a transmission line or cable having high shielding tolerance. Illustrated in FIGS. 30-32 is a cable having high shielding tolerances. FIG. 30 and FIG. 31 illustrates a completed cable 3002 having a connector 3004 in place at the end thereof. FIG. 31 illustrates a side view of the cable 3002. As illustrated, the shielding 3007 has been substantially applied right up to the connector base 3004. For example, the shielding may be applied within a distance of ¼ inch or less with respect to the connector base 3004. The distance between the practical limit of application of the shielding end 3009 and the connector base 3005 may correspond to the frequency of the data be transmitted through the cable 3002. The application of the shielding 3007 may also be limited by the physical properties of the materials used.

Illustrated in FIG. 32 is a cable 3202 that has been schematically drawn to show a multi level shielding application. The shielding 3205 may comprise a suitable metal layer 3207. The metal layer 3207 may be disposed near the connector 3210 and may vary in length as measured away from the connector base 3212.

In the foregoing Detailed Description, various features of the disclosure are grouped together in a single embodiment for the purpose of streamlining the disclosure. This method of disclosure is not to be interpreted as reflecting an intention that the claimed disclosure requires more features than are expressly recited in each claim. Rather, as the disclosure reflects, inventive aspects lie in less than all features of a single foregoing disclosed embodiment.

It is to be understood that the above-described arrangements are only illustrative of the application of the principles of the disclosure. Numerous modifications and alternative arrangements may be devised by those skilled in the art without departing from the spirit and scope of the disclosure and the disclosure is intended to cover such modifications and arrangements. Thus, while the disclosure has been shown in the drawings and described above with particularity and detail, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A method for transmitting data across a minimal number of differential pairs of transmission channels comprising:
determining a number of differential pairs of transmission channels to be used;
dividing video bus data into paired sub-data streams equal to the number of differential pairs of transmission channels;
dividing syncing information data into paired sub-syncing information data streams equal to the number of differential pairs of transmissions channels;
using a clock signal to control a serializer;
serializing said sub-data streams and said sub-syncing information data streams into serialized data streams;
transmitting said serialized data streams;
deserializing said serialized data streams into said sub-data streams and said sub-syncing information data streams; and
using sync information data to properly align the video bus data for processing by a processor.

2. The method of claim 1 further comprising using a single deserializer to deserialize the serialized data streams into said sub-data streams and said sub-syncing information data streams.

3. The method of claim 1 further comprising using a plurality of serializers to serialize said sub-data streams and said sub-syncing information data streams.

4. The method of claim 3 further comprising controlling the plurality of serializers with a clock signal from a clock.

5. The method of claim 4 further comprising dividing said clock signal by the number of serializers used.

6. The method of claim 1 further comprising using a plurality of deserializers to deserialize the serialized data streams into said sub-data streams and said sub-syncing information data streams.

7. The method of claim 6 further comprising controlling the plurality of deserializers with a clock signal from a clock.

8. The method of claim 7 further comprising dividing said clock signal by the number of deserializers used.

9. The method of claim 1, wherein the number of serializers used is equal to the number of deserializers used.

10. The method of claim 1, wherein a plurality serializers is used with a plurality of deserializers.

11. The method of claim 10, wherein a clock signal used to control said plurality of serializers and deserializers is divided by the sum of the plurality of serializers and deserializers.

12. The method of claim 1 further comprising using sync information data to compare with said clock signal.

13. The method of claim 12, wherein said sync information data is horizontal sync information.

14. The method of claim 12, wherein said sync information data is vertical sync information.

15. The method of claim 1 further comprising generating said video bus data and sync information data from a sensor within an imaging device.

16. An image processing circuit for transmitting data across a minimal number of differential pairs of transmission channels comprising:
an image sensor creating video bus data and syncing information data;
a first processor for dividing video bus data into paired sub-data streams equal to the number of differential pairs of transmission channels;
wherein said first processor divides said syncing information data into paired sub-syncing information data streams equal to the number of differential pairs of transmissions channels;
a clock for generating a clock signal to control a serializer;
a serializer for serializing said sub-data streams and said sub-syncing information data streams into serialized data streams;
a transmitter circuit that transmits said serialized data streams;
a deserializer for deserializing said serialized data streams into said sub-data streams and said sub-syncing information data streams; and
a second processor processing the sync information data so as to properly align the video bus data.

17. The image processing circuit of claim 16 further comprising a single deserializer to deserialize the serialized data streams into said sub-data streams and said sub-syncing information data streams.

18. The image processing circuit of claim 1 further comprising a plurality of serializers to serialize said sub-data streams and said sub-syncing information data streams.

19. The image processing circuit of claim 18 further comprising a clock that produces a clock signal for controlling the plurality of serializers with a clock signal from a clock.

20. The image processing circuit of claim 19 further comprising a clock signal for each the number of serializers used.

21. The image processing circuit of claim 16 further comprising a plurality of deserializers to deserialize the serialized data streams into said sub-data streams and said sub-syncing information data streams.

22. The image processing circuit of claim 21 further comprising a clock signal for controlling the plurality of deserializers.

23. The image processing circuit of claim 22 further comprising a clock signal equal to the number of deserializers used.

24. The image processing circuit of claim 16 further comprising a plurality of serializers equal to the number of deserializers used in the circuit.

25. The image processing circuit of claim 16 further comprising a plurality serializers and a corresponding plurality of deserializers.

26. The image processing circuit of claim 25, wherein a clock signal used to control said plurality of serializers and deserializers that has been divided by the sum of the plurality of serializers and deserializers.

27. The image processing circuit of claim 16 further comprising sync information data to compare with said clock signal.

28. The image processing circuit of claim 27, wherein said sync information data is horizontal sync information.

29. The image processing circuit of claim 27, wherein said sync information data is vertical sync information.

30. An imaging system comprising:
a control unit comprising:
an imaging device input;
a single use imaging device comprising:
a housing;
a memory;
an image sensor;
an opening configured to facilitate the transmission of light from optics to the image sensor;
wherein a serial number is stored in said memory for providing identification of the imaging device;
a communication connection between said imaging device and said control unit; and
an image processing circuit for transmitting data across a minimal number of differential pairs of transmission channels to said control unit comprising:
video bus data and syncing information data derived from said image sensor;
a first processor for dividing video bus data into paired sub-data streams equal to the number of differential pairs of transmission channels;
wherein said first processor divides syncing information data into paired sub-syncing information data streams equal to the number of differential pairs of transmissions channels;
a clock for generating a clock signal to control a serializer;
a serializer for serializing said sub-data streams and said sub-syncing information data streams into serialized data streams;
a transmitter for transmitting said serialized data streams;
a deserializer for deserializing said serialized data streams into said sub-data streams and said sub-syncing information data streams; and
a second processor processing the sync information data so as to properly align the video bus data.

31. The imaging system of claim 30, wherein said image sensor is electrically connected to a main circuit having the memory thereon.

32. The imaging system of claim 30, wherein the system further comprises a counting circuit that is configured to cause a count value to be recorded in said memory for each time the imaging device is used.

33. The imaging system of claim 30, wherein a timing circuit causes a date and time value to be recorded in said memory when a main circuit is powered on and said timing circuit further records the amount of time the imaging device is in use in said memory.

34. The imaging system of claim 30, wherein the system further comprises data recorded in memory representing a date the imaging device was last sterilized.

35. The imaging system of claim 30, wherein the system further comprises data recorded in memory representing user settings.

36. The imaging system of claim 30, wherein the system further comprises data recorded in memory representing procedure specific settings.

37. The imaging system of claim 30, wherein the system further comprises data recorded in memory representing a location of manufacture.

38. The imaging system of claim 30, wherein the system further comprises data recorded in memory representing a date of manufacture.

39. The imaging system of claim 30, wherein the system further comprises data recorded in memory representing a date the imaging device was last quality control checked.

40. The imaging system of claim 30, wherein the system further comprises imaging device diagnostic data for use with a second complimentary apparatus.

41. The imaging system of claim 30, wherein the control unit comprises video outputs; and wherein the system further comprises an electronic communication circuit that is a tether of wires having an electronic connector configured to mate with a corresponding electronic connector on said control unit.

42. The imaging system of claim 30, wherein said imaging device further comprises a heat sink.

43. The imaging system of claim 30, wherein the system further comprises a counting circuit that is configured to cause a count value to be recorded in said memory for each time the imaging device is used.

44. The imaging system of claim 30, wherein the system further comprises a timing circuit that causes a date and time value to be recorded in said memory when a main circuit is powered on and said timing circuit further records the amount of time the imaging device is in use in said memory.

45. The imaging system of claim 30, wherein the serializer is physically located within the imaging device, and the deserializer is physically located within the control unit.

46. The imaging system of claim 30, further comprising a shielded cable having shielding within a quarter inch or less of a connector base.
